(19) United States
(12) Patent Application Publication
(10) Pub. No.: US 2010/0082934 A1
(43) Pub. Date: Apr. 1, 2010

(54) COMPUTER SYSTEM AND STORAGE SYSTEM

(75) Inventors: Yuki Naganuma, Yokohama (JP); Shinichiro Kanno, Odawara (JP); Hirotaka Nakagawa, Sagamihara (JP); Masayasu Asano, Yokohama (JP); Hirokazu Ikeda, Yamato (JP)

Correspondence Address: BRUNDIDGE & STANGER, P.C., 1700 DIAGONAL ROAD, SUITE 330, ALEXANDRIA, VA, 22314, US

(73) Assignee: Hitachi, Ltd.

(21) Appl. No.: 12/275,271

(22) Filed: Nov. 21, 2008

(30) Foreign Application Priority Data
Sep. 26, 2008 (JP) 2008-247530

(51) Int. Cl. G06F 12/02; G06F 12/00

(52) U.S. Cl. 711/170; 711/E12.002

(57) ABSTRACT

In order to manage and operate Pool created in storage system A and a virtual volume using Pool in storage system B, it is required to copy the virtual volume of storage system A into a virtual volume of storage system B and new storage regions for copy of virtual volume into storage system B are needed. Storage system B acquires configuration information of Pool and a virtual volume of storage system A and inputs a logical volume included in Pool of storage system A to storage system B based on the acquired configuration information. Storage system B transforms the acquired configuration information for use in storage system B and creates Pool and a virtual volume from the input logical volume based on the transformed configuration information.

### CROSS REFERENCES TO RELATED APPLICATIONS

This application relates to and claims priority from Japanese Patent Application No. 2008-247530, filed on Sep. 26, 2008, the entire disclosure of which is incorporated herein by reference.

### BACKGROUND OF THE INVENTION

1. Field of the Invention

The present invention relates to a storage system equipped with a thin provisioning function, and more particularly, to a method of implementing a virtual volume configuration.

2. Description of the Related Art

A storage system providing storage regions storing data to a host computer has physical disks such as multiple hard disks to store data. The storage system configures a RAID (Redundant Array of Independent Disks) group by making storage regions of a plurality of physical disks redundant using a RAID technique. The storage system creates a logical volume, as a storage region of capacity required by the host computer, from a portion of the RAID group and provides the created logical volume to the host computer.

There has been known a so-called thin provisioning technique. The thin provisioning refers to a technique for providing a virtual logical volume (virtual volume) to a host computer, instead of providing a storage region of fixed capacity to the host computer like a logical volume, and allocating a storage region having segments as units from a storage region (Pool) created with a plurality of logical volumes to the virtual volume in response to a writing process and the like from the host computer. There has been known a storage system which dynamically extends storage capacity to be provided to a host computer using such a thin provisioning technique (for example, see Patent Document 1).

A segment refers to a storage region set by partitioning a logical volume contained in a pool into appropriate smaller capacities by means of a logic block address (LBA). An LBA refers to an address used for specifying a location on a logical volume when a host computer reads and writes data.

In addition, for two storage systems (storage system A and storage system B) interconnected by a data communication network such as SAN (Storage Area Network), there has been known a technique in which a logical volume of the storage system A is input to the storage system B and the input logical volume is provided, as a logical volume of the storage system B, to a host computer (hereinafter referred to as “external connection”) by making the logical volume of the storage system A correspond to a virtual volume created in the storage system B by the storage system B (for example, see Patent Document 2).

Such an external connection technique may be used to extend capacity of the storage system B which inputs the logical volume. Thus, since the storage system B which inputs the logical volume provides the logical volume to the host computer, the storage system can be easily managed.
[Patent Document 1] JP-A-2003-15915
[Patent Document 2] JP-A-10-283272

### SUMMARY OF THE INVENTION

There is a desire to use a virtual volume of the storage system A having a Pool and virtual volumes allocated with segments of the Pool in, for example, the storage system B having higher performance than that of the storage system A or a desire for a manager to use the storage system B for intensive management.

In this case, there is a method of externally connecting the virtual volume of the storage system A to the storage system B and treating the virtual volume of the storage system A as a logical volume of the storage system B.

However, this method requires management of two storage systems as the storage system B has to make a management such as providing the virtual volume of the storage system A to a host computer and the storage system A has to make a management such as adding or deleting a logical volume included in the Pool.

In addition, in order to manage the Pool and the virtual volumes using the Pool of the storage system A with only the storage system B, instead of the management of the two storage systems, there is a need to move both of the Pool and the virtual volumes using the Pool from the storage system A to the storage system B.

In this case, the technique disclosed in Patent Document 2 had to use the following method.

First, a new Pool is created in the storage system B and a virtual volume using segments of the created Pool is created. Next, data of a virtual volume of the storage system A is copied to a virtual volume created in the storage system B and then both of the Pool and the virtual volume using the Pool are moved from the storage system A to the storage system B.

However, as described above, in order to carry out data copy followed by movement, there is a need to secure beforehand a storage region sufficient to preserve data copied from the virtual volume of the storage system A in the Pool of the storage system B.

In the meantime, after completion of the data copy, since the virtual volume of the storage system B is provided to the host computer, the storage region used to store data of the virtual volume by the storage system A becomes unnecessary.

In other words, in the course of data copying, both of the copy source storage system and the copy target storage system have to secure storage regions required to copy data of the virtual volume, which results in excessive resource consumption.

According to a typical aspect of the invention, there is provided a computer system including: a first storage system including a pool, the pool including a plurality of volumes, each of which being a storage region of data provided to a host computer; and a second storage system connected to the first storage system. The first storage system includes an interface connected to the host computer, an interface connected to the second storage system, a first processor connected to the interfaces and a first memory connected to the first processor and manages first configuration information indicating a correspondence relation between the plurality of volumes and the pool. The second storage system includes an interface connected to the host computer, an interface connected to the first storage system, a second processor connected to the interfaces and a second memory connected to the second processor. The second processor acquires the first configuration information from the first storage system, specifies a volume included in the pool of the first storage system by referring to the acquired first configuration information, causes the specified volume to correspond to an external volume that can be handled by the second storage system, and creates a pool having the same configuration as the pool of the first storage system in the second storage system using the corresponding external volume based on the acquired first configuration information.

According to an embodiment of the present invention, storage system B can move Pool and a virtual volume of storage system A to storage system B, and Pool and a virtual volume having the same configuration as Pool and the virtual volume of storage system A can be managed by only storage system B.

In addition, for migration of Pool and a virtual volume from storage system A to storage system B, only storage regions into which data of logical volumes included in Pool of storage system A are copied are required without requiring additional storage regions to store other data.

### BRIEF DESCRIPTION OF THE DRAWINGS

FIG. 1 is a block diagram showing a configuration of a computer system according to a first embodiment of the present invention.

FIG. 2 is a block diagram showing a configuration of a controller of storage system A according to the first embodiment of the present invention.

FIG. 3 is a block diagram showing a configuration of a controller of storage system B according to the first embodiment of the present invention.

FIG. 4 is an explanatory view showing a configuration of a volume and so on of a storage system according to the first embodiment of the present invention.

FIG. 5 is an explanatory view showing a configuration of LU map table A according to the first embodiment of the present invention.

FIG. 6 is an explanatory view showing a configuration of segment management table A according to the first embodiment of the present invention.

FIG. 7 is an explanatory view showing a configuration of virtual Vol management table A according to the first embodiment of the present invention.

FIG. 8 is an explanatory view showing a configuration of interstorage path table B according to the first embodiment of the present invention.

FIG. 9 is a flow chart showing a process of virtual Vol migration unit I according to the first embodiment of the present invention.

FIG. 10 is an explanatory view showing an outline of a process of moving a virtual volume according to the first embodiment of the present invention.

FIG. 11 is a flow chart showing a process of acquiring configuration information of a pool and a virtual volume according to the first embodiment of the present invention.

FIG. 12 is an explanatory view showing an example of an error display screen according to the first embodiment of the present invention.

FIG. 13 is a flow chart showing a process of connecting a logical volume to the outside according to the first embodiment of the present invention.

FIG. 14 is a flow chart showing a process of transforming configuration information of a Pool and a virtual volume according to the first embodiment of the present invention.

FIG. 15 is a flow chart showing a process of creating a Pool and a virtual volume in storage system B according to the first embodiment of the present invention.

FIG. 16 is an explanatory view showing an example of configuration of LU map table A at the time of external connection of a logical volume according to the first embodiment of the present invention.

FIG. 17 is an explanatory view showing an example of configuration of external connection Vol map table B at the time of external connection of a logical volume according to the first embodiment of the present invention.

FIG. 18 is an explanatory view showing an example of configuration of an external connection LDEV reference table at the time of external connection of a logical volume according to the first embodiment of the present invention.

FIG. 19 is an explanatory view showing an example of configuration of segment management table B according to the first embodiment of the present invention.

FIG. 20 is an explanatory view showing an example of configuration of virtual Vol management table B according to the first embodiment of the present invention.

FIG. 21 is a block diagram showing a configuration of a computer system according to a modification of the first embodiment of the present invention.

FIG. 22 is an explanatory view showing an example of a screen for setting Pool migration according to the first embodiment of the present invention.

FIG. 23 is an explanatory view showing an example of a screen for displaying a migration result according to the first embodiment of the present invention.

FIG. 24 is an explanatory view showing a configuration of a controller of storage system A according to a second embodiment of the present invention.

FIG. 25 is an explanatory view showing a configuration of a controller of storage system B according to the second embodiment of the present invention.

FIG. 26 is a flow chart showing a process of virtual Vol migration unit II according to the second embodiment of the present invention.

FIG. 27 is a flow chart showing a process of a configuration information difference processing unit according to the second embodiment of the present invention.

### DETAILED DESCRIPTION OF PREFERRED EMBODIMENTS

The outline of the present invention is as follows.

First, storage system B acquires segment configuration information that describes a correspondence relation between logical volumes included in a Pool of storage system A and segments of the Pool and virtual volume configuration information that describes a correspondence relation between virtual volumes and segments allocated to the virtual volumes from storage system A.

Next, storage system B specifies the logical volume included in the Pool of storage system A by referring to the acquired segment configuration information of storage system A.

Then, storage system B externally connects the specified logical volume to storage system B and inputs the externally connected logical volume of storage system A to storage system B. Then, storage system B creates a Pool and a virtual volume using the Pool from the input logical volume of storage system A.

Then, storage system B allocates segments of the Pool to the virtual volume by the same allocation as segments of the Pool of storage system A by referring to the virtual volume configuration information acquired from storage system A. Thus, the virtual volume having the same configuration as storage system A is created in storage system B.

### First Embodiment

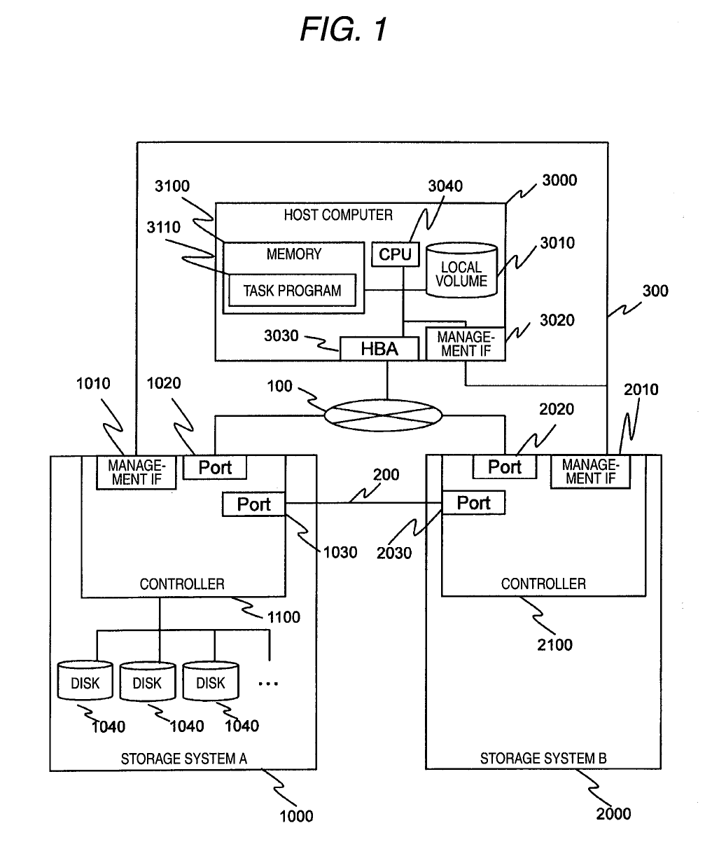

Hereinafter, a first embodiment of the present invention will be described with reference to FIGS. 1 to 23. In the following description, the first embodiment is one of various embodiments of the present invention and is not intended to limit the scope of the invention.

FIG. 1 is a block diagram showing a configuration of a computer system according to the first embodiment of the present invention.

The computer system of the first embodiment includes storage system A 1000, storage system B 2000 and a host computer 3000 using logical volumes of storage system B 2000 (or storage system A 1000), and storage system A 1000, storage system B 2000 and host computer 3000 are interconnected via a data communication network 100 such as SAN or LAN (Local Area Network).

In addition, storage system A 1000 and storage system B 2000 are interconnected via a data communication network 200, such as SAN or LAN, which is separated from the network 100.

Although it is illustrated in the first embodiment that storage system A 1000 and storage system B 2000 are interconnected via the network 200, the network 200 is not necessarily required as long as storage system A 1000 and storage system B 2000 can interchange preserved data irrespective of the host computer.

Alternatively, storage system A 1000, storage system B 2000 and the host computer 3000 may be interconnected via a data communication network 300, such as LAN, by their respective management interfaces.

In the following description, when storage system A 1000 and storage system B 2000 are simultaneously described, storage system A 1000 and storage system B 2000 are generically referred to as storage system(s).

As shown, the host computer 3000, such as a personal computer or a workstation, includes a local volume 3010 which stores data, a memory 3100 which temporarily stores data, a CPU 3040 which performs computing processes, a management IF 3020 and an HBA (Host Bus Adapter) 3030. The host computer 3000 may further include an input device such as a keyboard or the like, and an output device such as a display or the like (not shown).

The memory 3100 stores a task program 3110 for managing a database and so on. The task program 3110 stores data in a storage region provided from the storage system.

The HBA (Host Bus Adapter) 3030 is an interface for connecting the host computer 3000 to the storage system via the network 100. The management IF 3020 is an interface through which a management computer (not shown) manages the host computer 3000 via the network 300 such as LAN.

Although it is illustrated in the first embodiment that the interface of the network 100 is HBA, this interface may be any interface suitable to the network 100.

Storage system A 1000 includes a controller 1100 for controlling input/output and configuration of data and a plurality of physical disks 1040 for storing data. The controller 1100 includes a management IF 1010, which is a management interface through which an external device operates the number of configuration information of logical volumes managed by the controller 1100, and data input/output interfaces Port 1020 and Port 1030.

Port 1020 is Port for connecting storage system A to the host computer 3000 and so on via the network 100 such as SAN. Port 1030 is Port for connecting storage system A 1000 to storage system B 2000 which will be described later.

If storage system A 1000 can provide a logical volume to the host computer 3000 via one Port and the logical volume can be externally connected to storage system B 2000 via one Port, Port 1020 may be the same as Port 1030.

Storage system B 2000 has the same configuration as storage system A 1000. Storage system B 2000 includes a controller 2100 for controlling input/output and configuration of data.

The controller 2100 includes a management IF 1010, which is a management interface for management of logical volumes, Port 2020, which is an interface for connection to the host computer 3000, and Port 1030, which is an interface for connection to storage system A 1000.

It is here noted that storage system B 2000 does not necessarily include physical disks such as the physical disks 1040 of storage system A 1000.

The management IFs 1010, 2010 and 3020 may be simply a LAN connection Port, or alternatively may be connected to a management computer (not shown) including an output device such as a display or the like and an input device such as a keyboard or the like via the network 300 such as LAN. The management IFs 1010, 2010 and 3020 may be connected to the management computer via a network such as SAN instead of LAN.

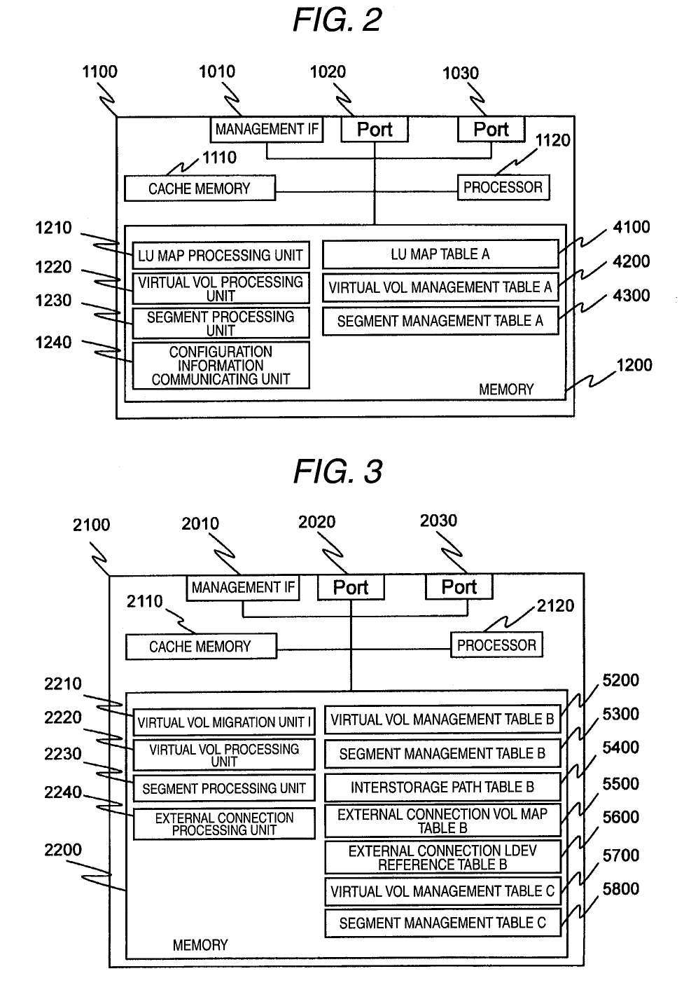

Next, the internal configuration of the controller 1100 of storage system A 1000 and the internal configuration of the controller 2100 of storage system B 2000 will be described with reference to FIGS. 2 and 3, respectively.

FIG. 2 is a block diagram showing a configuration of the controller of storage system A according to the first embodiment of the present invention.

The controller 1100 of storage system A 1000 includes a cache memory 1110, a management memory 1200 and a processor 1120, in addition to the management IF 1010, Port 1020 and Port 1030.

The processor 1120 controls storage system A 1000 by a control program stored in the memory 1200. The cache memory 1110 temporarily stores some of data stored in storage system A 1000 and reads out the data based on a request from the host computer 3000.

The memory 1200 stores programs for implementing an LU map processing unit 1210, a virtual Vol processing unit 1220, a segment processing unit 1230 and a configuration information communicating unit 1240. The memory 1200 further stores LU map table A 4100, virtual Vol management table A 4200 and segment management table A 4300.

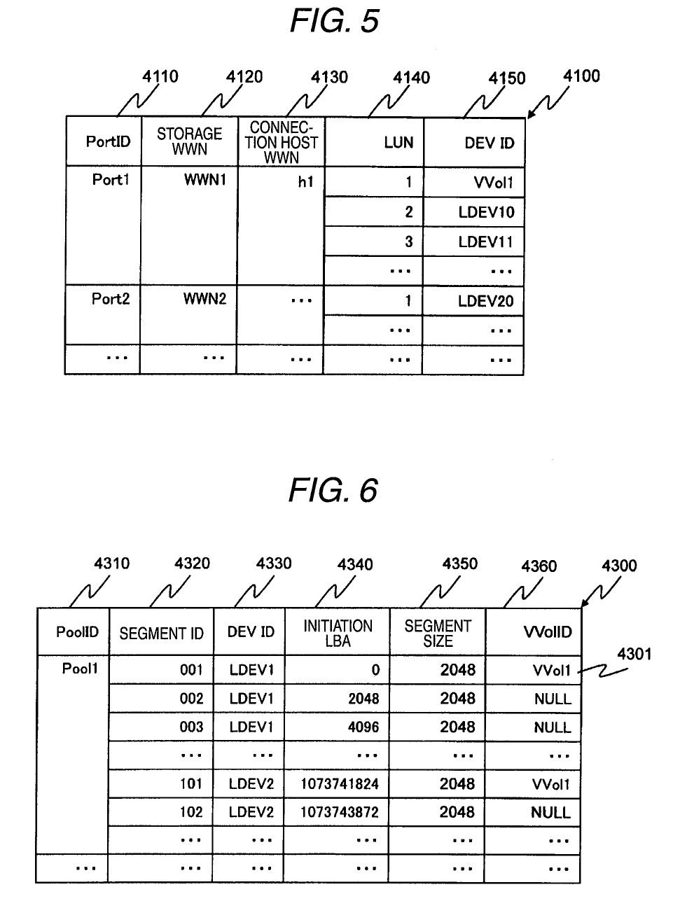

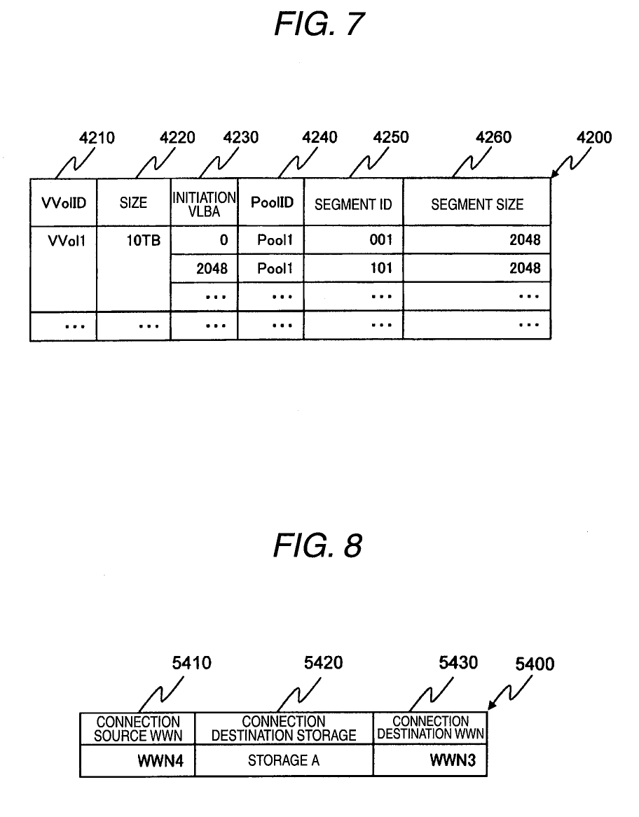

The above processing units will be described later. LU map table A 4100 will be described later with reference to FIG. 5. Virtual Vol management table A 4200 will be described later with reference to FIG. 7. Segment management table A 4300 will be described later with reference to FIG. 6.

FIG. 3 is a block diagram showing a configuration of the controller of storage system B according to the first embodiment of the present invention.

The controller 2100 of storage system B 2000 has the same configuration as the controller 1100 of storage system A 1000. However, programs and configuration information tables stored in a memory 2200 of the controller 2100 is different from those stored in the memory 1200 of the controller 1100.

The memory 2200 stores programs for implementing virtual Vol migration unit I 2210, a virtual Vol processing unit 2220, a segment processing unit 2230 and an external connection processing unit 2240. The memory 2200 further stores virtual Vol management table B 5200, segment management table B 5300, interstorage path table B 5400, external connection Vol map table B 5500, external connection LDEV reference table B 5600, virtual Vol management table C 5700 and segment management table C 5800.

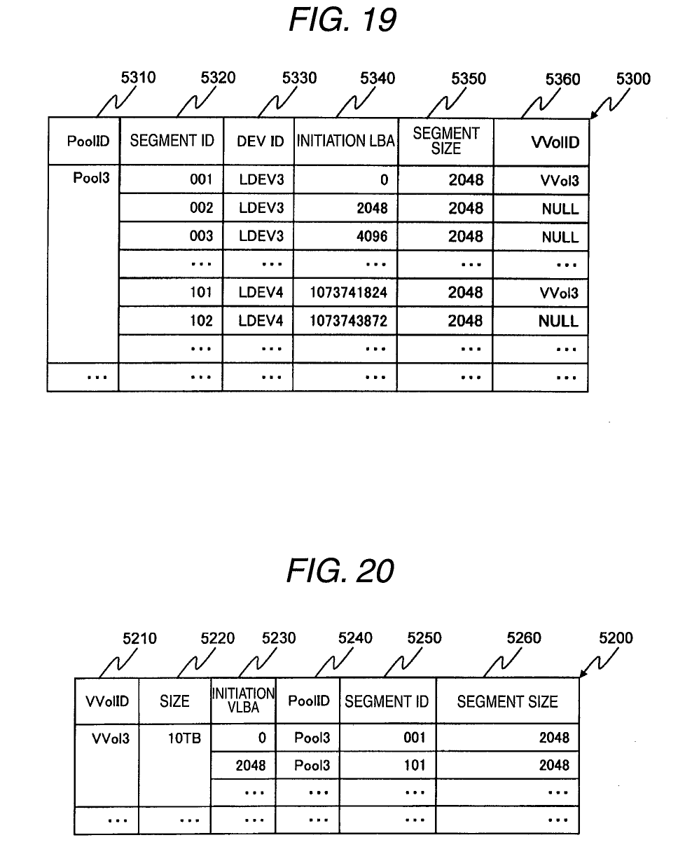

The above processing units will be described later. Virtual Vol management table B 5200 will be described later with reference to FIG. 20. Segment management table B 5300 will be described later with reference to FIG. 19. Interstorage path table B 5400 will be described later with reference to FIG. 8. External connection Vol map table B 5500 will be described later with reference to FIG. 17. External connection LDEV reference table B 5600 will be described later with reference to FIG. 18.

Virtual Vol management table C 5700 has the same configuration as that of virtual Vol management table A 4200 shown in FIG. 7. Segment management table C 5800 has the same configuration as that of segment management table A 4300 shown in FIG. 6. Virtual Vol management table C 5700 and segment management table C 5800 will be described later.

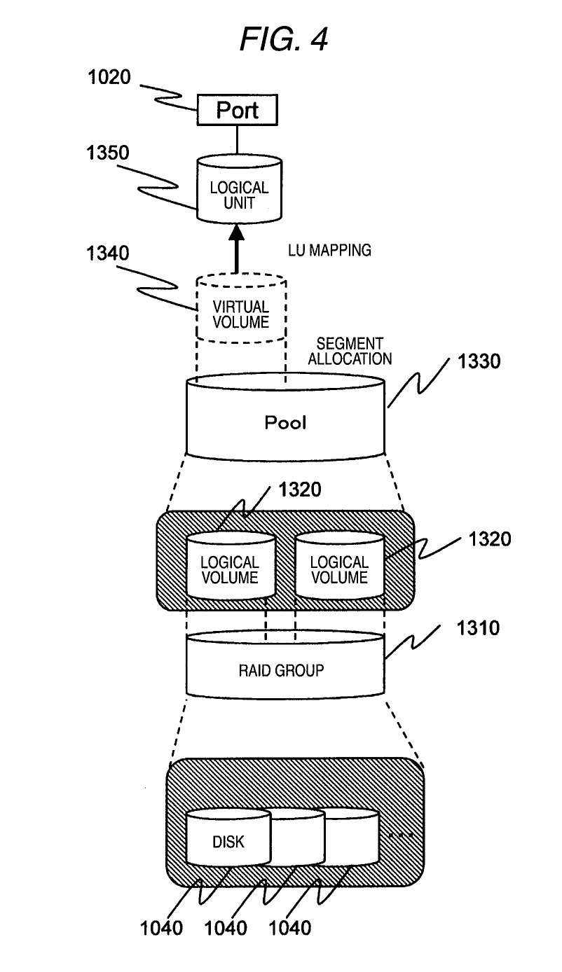

The controller 1100 (or controller 2100) manages logical volumes and so on for execution of a request for read/write of data from/to the host computer 3000. Next, a structure of a logical volume and so on will be described with reference to FIG. 4.

FIG. 4 is an explanatory view showing a configuration of a volume and so on of the storage system according to the first embodiment of the present invention.

The plurality of physical disks 1040 of the storage system is made redundant by RAID and configures a RAID group 1310. The RAID group 1310 is divided into logical blocks, each of which is given address information called a logical block address (LBA). A logical volume 1320 partitioned into LBA areas having an appropriate size is created in the RAID group 1310.

For the purpose of realizing a thin provisioning function, the plurality of logical volume 1320 creates a storage region called a Pool 1330. The logical volumes 1320 included in Pool 1330 are divided into segments created by a certain number of logical blocks. The controller of the storage system manages the logical volume 1320 with the segments.

A virtual volume 1340 is dynamically extended in its capacity as the segments of Pool 1330 are allocated thereto as necessary, unlike the logical volume 1320 whose capacity of storage region is fixed at the point of time when it is created.

The controller makes the logical volume 1320 or the virtual volume 1340 corresponding to a logical unit 1350 and provides the logical volume 1320 or the virtual volume 1340 to the host computer 3000. The logical unit 1350 is identified by LUN (Logical Unit Number) uniquely set for each Port 1020, and the host computer 3000 recognizes the logical unit 1350 by LUN.

The host computer 3000 uses LUN and LBA, which is an address value of the logical volume 1320, to write/read data in/from the logical volume 1320 or the virtual volume 1340 corresponding to the logical unit 1350 connected to Port 1020. Here, the correspondence of the logical volume 1320 or the virtual volume 1340 to LUN of the logical unit 1350 is called an LU mapping.

Next, programs and tables stored in the memory 1200 of the controller 1100 of storage system A 1000 will be described.

The LU map processing unit 1210 uses LU map table A 4100, which will be described later with reference to FIG. 5, to manage an LU mapping correspondence relation between LUN of the logical unit 1350 recognized by the host computer 3000 connected to Port 1020 and DEVID, which is an identifier of the logical volume used in storage system A 1000.

Storage system B 2000 may manage the LU map processing unit 1210 and LU map table A 4100 of storage system A 1000. The LU map processing unit 1210 may have a function to prevent an unauthorized host computer 3000 from inputting/outputting data.

FIG. 5 is an explanatory view showing a configuration of LU map table A according to the first embodiment of the present invention.

LU map table A 4100 is one example of LU map tables of the controller 1100 of storage system A 1000. LU map table A 4100 includes PortID 4110, storage WWN (World Wide Name) 4120, access host WWN, LUN 4140 and DEVID 4150.

PortID 4110 is an identifier of Port (Port 1020 and so on) of storage system A 1000. Storage WWN 4120 is WWN of the storage system, which is given for each PortID 4110, and is an unique identifier on SAN (network 100). Access host WWN 4130 is an identifier of the host computer 3000 connected to each Port, which is given to HBA 3030 which is an interface of the host computer 3000.

LUN 4140 is an identifier of the logical unit 1350 created in storage system A 1000 recognized by the host computer 3000. DEVID 4150 is an identifier of the logical volume 1320 or the virtual volume 1340 corresponding to the logical unit 1350 of storage system A 1000.

For example, “Port1” of storage system A 1000 is allocated “WWN1” and is connected to the host computer 3000 whose WWN of HBA is “h1.” The logical unit of storage system A 1000 recognized by the host computer 3000 is “LUN1,” which corresponds to a virtual volume “VVol1” of storage system A 1000.

The logical unit “LUN2” recognized by the host computer 3000 corresponds to a logical volume “LDEV10” of storage system A 1000.

The segment processing unit 1230 uses segment management table A 4300, which will be described later with reference to FIG. 6, to manage a correspondence relation between segments allocated to the virtual volume 1340 and the logical volume and add or delete a logical volume included in Pool 1330. The segment processing unit 1230 of storage system A 1000 manages segment management table A 4300 and the segment processing unit 2230 of storage system B 2000 manages segment management table B 5300 which will be described later.

FIG. 6 is an explanatory view showing a configuration of segment management table A according to the first embodiment of the present invention.

Segment management table A 4300 is one example of segment management tables of storage system A 1000. Segment management table A 4300 includes PoolID 4310, segment ID 4320, DEVID 4330, initiation LBA 4340, segment size 4350 and VVolID 4360.

Segment management table A 4300 is managed for each identifier (PoolID 4310) of Pool 1330 created in storage system A 1000.

Segment ID 4320 is an identifier of a segment allocated to Pool indicated by PoolID 4310. DEVID 4330 is an identifier of the logical volume 1320 corresponding to the segment indicated by segment ID 4320. Initiation LBA 4340 is an initiation address of a storage region of the logical volume 1320 indicated by DEVID 4330. Segment size 4350 is capacity of the segment indicated by segment ID 4320. VVolID 4360 is an identifier of the virtual volume 1340 allocated with the segment indicated by segment ID 4320.

If a segment is allocated to the virtual volume 1340, VVolID 4360 is marked with an identifier of the virtual volume. If not so, VVolID 4360 is marked with “NULL” as a control character, for example.

The virtual Vol processing unit 1220 uses virtual Vol management table A 4200, which will be described later with reference to FIG. 7, to create the virtual volume 1340 provided to the host computer 3000, control capacity of the virtual volume 1340 and manage the virtual volume 1340 by allocating a segment to the created virtual volume 1340.

The virtual Vol processing unit 1220 of storage system A 1000 manages virtual Vol management table A 4200 and the virtual Vol processing unit 2220 of storage system B 2000 manages virtual Vol management table B 5200.

FIG. 7 is an explanatory view showing a configuration of virtual Vol management table A according to the first embodiment of the present invention.

Virtual Vol management table A 4200 is one example of virtual Vol management tables of storage system A 1000. Virtual Vol management table A 4200 includes VVolID 4210, size 4220, initiation VLBA 4230, PoolID 4240, segment ID 4250 and segment size 4260.

VVolID 4210 is an identifier of the virtual volume 1340. Size 4220 is capacity set when the virtual volume is first created. Initiation VLBA 4230 is a logical block address to specify a virtual block (VLBA) of the virtual volume 1340 to/from which the host computer 3000 inputs/outputs data. PoolID 4240 is an identifier of Pool 1330 to allocate a segment to the virtual volume 1340. Segment ID 4250 and segment size 4260 are an identifier and capacity of a segment corresponding to VLBA of the virtual volume 1340 indicated by VVolID 4210, respectively.

If there is only one Pool created in storage system A 1000, virtual Vol management table A 4200 may not include PoolID 4240.

Thus, for example, when the host computer 3000 reads data from a virtual block specified by initiation VLBA “3048 (=2048+1000)” of a virtual volume “VVol1,” the controller 1100 of storage system A 1000 can know that data is stored in a segment “101” allocated to “Pool1,” by referring to virtual Vol management table A 4200.

In addition, by referring to segment management table A 4300, the controller 1100 of storage system A 1000 can know that the segment “101” is a logical block specified by an LBA value “1073741824+1000” of a logical volume “LDEV2” and data is stored in the specified logical block.

In this manner, virtual Vol management table A 4200 makes a VLBA value of the virtual volume 1340 corresponding to an LBA value of the logical volume 1320.

If an event of writing occurs in VLBA of the virtual volume 1340 to which a segment is not allocated, the virtual Vol processing unit 1220 allocates an unused segment (that is, a segment marked with “NULL” in VVolID 4360) to the virtual volume 1340 by referring to segment management table A 4300. Thus, the virtual Vol processing unit 1220 can dynamically extend capacity of the virtual volume 1340.

FIG. 8 is an explanatory view showing a configuration of interstorage path table B according to the first embodiment of the present invention.

The controller 2100 of storage system B 2000 stores a correspondence relation of Port for data transmission/receipt between storage systems in interstorage path table B 5400 shown in FIG. 8. Interstorage path table B 5400 includes connection source WWN 5410, a connection destination storage 5420 and connection destination WWN 5430.

Connection source WWN 5410 is an identifier given for Port of the storage system (here, storage system B 2000) which is a connection source. The connection destination storage 5420 is an identifier of the storage system (here, storage system A 1000) which is a connection destination. Connection destination WWN is an identifier given for Port of the storage system as the connection destination.

In the example shown in FIG. 8, Port 2030 of storage system B 2000 which is given “WWN4” is connected to Port 1030 of storage system A 1000 which is given “WWN3.”

In the first embodiment, interstorage path table B 5400 is created after the two storage systems are physically interconnected and a connection setup is completed by general storage system management software. Storage system B 2000 includes the created interstorage path table B 5400.

If storage system B 2000 has a function to automatically examine Port of another storage system connected thereto and automatically create interstorage path table B 5400, storage system B 2000 may create interstorage path table B 5400 using this function.

The controller 2100 of storage system B 2000 further includes an external connection processing unit 2240. The external connection processing unit 2240 manages external connection Vol map table B 5500 which will be described later with reference to FIG. 17.

The external connection processing unit 2240 is externally connected to the logical volume 1320 of another storage system (storage system A 1000) and inputs the logical volume 1320, as a logical volume 2321 of storage system B 2000, to another storage system. Storage system B 2000 can provide the input logical volume 2321 to the host computer 3000. Detailed operation executed by the external connection processing unit 2240 will be described below.

For example, if Port 2030 of storage system B 2000 which is given “WWN4” is connected to Port 1030 of storage system A 1000 which is given “WWN3” and the logical volume 1320 corresponds to Port 1030 which is given “WWN3”, as the logical unit 1350 which is given LUN, the external connection processing unit 2240 of storage system B 2000 allocates DEVID used in storage system B 2000 to the logical volume 1320 of storage system A 1000, which corresponds to the logical unit 1350. Thus, storage system B 2000 can treat the logical volume 1320 of the externally connected storage system A 1000 as the logical volume 2321 of storage system B 2000.

External connection Vol map table B 5500 is shown in FIG. 17, details of which will be described later with reference to a flow chart.

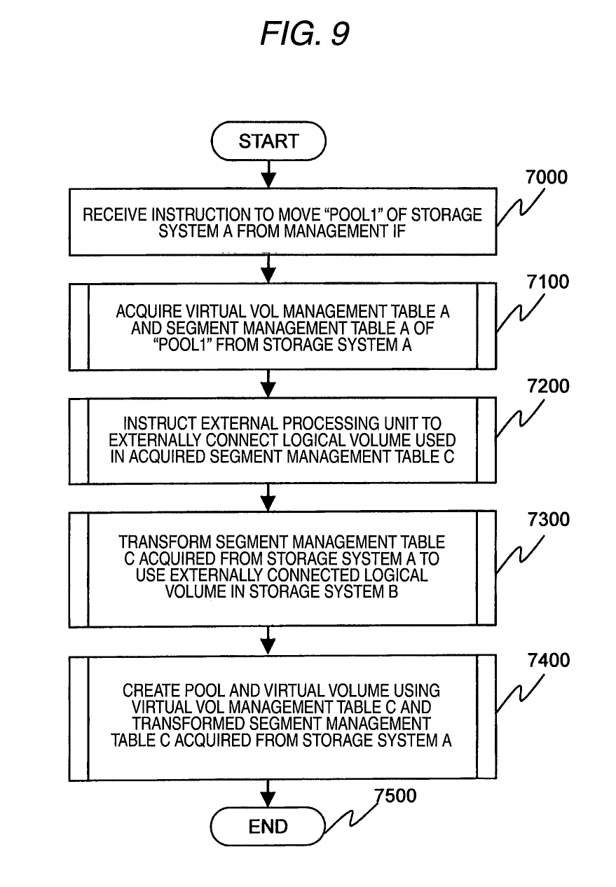

The controller 1100 of storage system A 1000 further includes a configuration information communicating unit 1140. The controller 2100 of storage system B 2000 further includes virtual Vol migration unit I 2210. Operation of virtual Vol migration unit I 2210 will be described later with reference to FIGS. 9 to 15.

The configuration information communicating unit 1140 transmits configuration information tables in storage system A 1000 to virtual Vol migration unit I 2210 according to a request from virtual Vol migration unit I 2210. The configuration information tables may be transmitted either via the network 300 through the management IF 1010 or via the network 100 (or network 200) through Port 1020 (or Port 1030).

The controller 2100 of storage system B 2000 further includes external connection LDEV reference table B 5600, virtual Vol management table C 5700 and segment management table C 5800.

External connection LDEV reference table B 5600 is a table describing a correspondence relation between the logical volume 1320 of storage system A 1000 and DEVID of an external connection volume of storage system B 2000 which is externally connected to the logical volume 1320. External connection LDEV reference table B 5600 will be described in more detail later with reference to FIG. 18.

Segment management table C 5800 has the same configuration as segment management table A 4300 shown in FIG. 6. Virtual Vol management table C 5700 has the same configuration as virtual Vol management table A 4200 shown in FIG. 7.

Although segment management table C 5800 and virtual Vol management table C 5700 are illustrated in the first embodiment, segment management table C 5800 and virtual Vol management table C 5700 are not tables used to manage Pool and virtual volumes of storage system B 2000 but are tables temporarily created in the course of process of the first embodiment, which are not necessarily required.

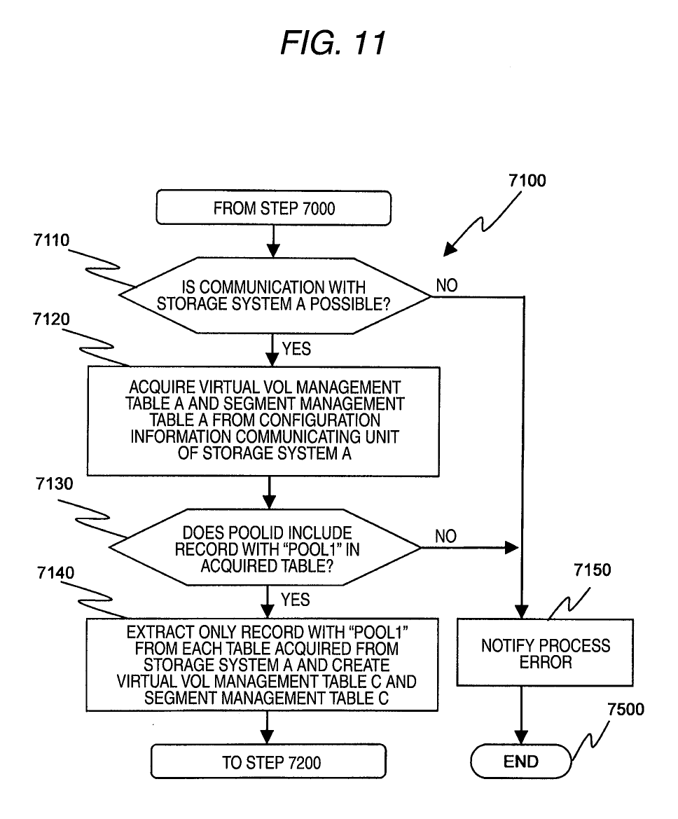

External connection LDEV reference table B 5600, virtual Vol management table C 5700 and segment management table C 5800 will be described in more detail later with reference to FIG. 11.

Hereinafter, the outline of migration process of a virtual volume in the first embodiment will be described.

Before migration process of a virtual volume, storage system A 1000 has the table configuration shown in FIGS. 5, 6 and 7 and storage system B 2000 has the table configuration shown in FIG. 8.

For the purpose of illustration, storage system A 1000 has the logical volume 1320 (its identifier being “LDEV1” and “LDEV2”) and Pool 1330 (its identifier being “Pool1”) created by the logical volume 1320 of “LDEV1” and “LDEV2.”

In addition, storage system A 1000 has the virtual volume 1340 (its identifier being “VVol1”) to which a segment of Pool (its identifier being “Pool1”) is allocated. Since it is possible to cause the host computer 3000 not to use the logical volume 1320 using a general management program or the like, the virtual volume 1340 is assumed to be not used by the host computer 3000.

The configurations of the logical volume 1320, Pool 1330 and the virtual volume 1340 are only examples, and the number thereof may be changed depending on operation of storage system A 1000.

FIG. 9 is a flow chart showing a process of virtual Vol migration unit I according to the first embodiment of the present invention.

Steps 7000 to 7500 shown in FIG. 9 are virtual volume migration process executed by virtual Vol migration unit I 2210.

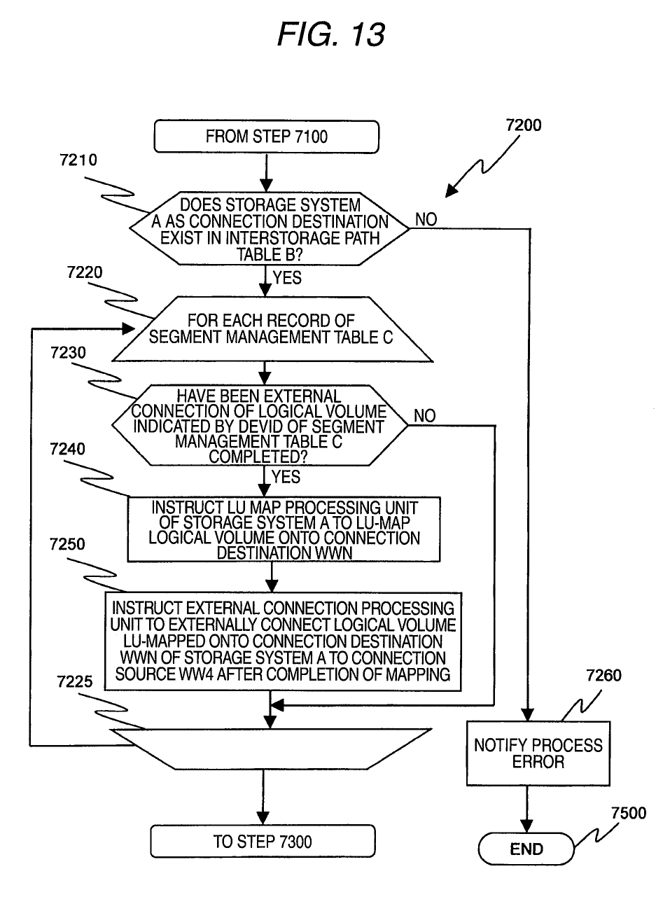

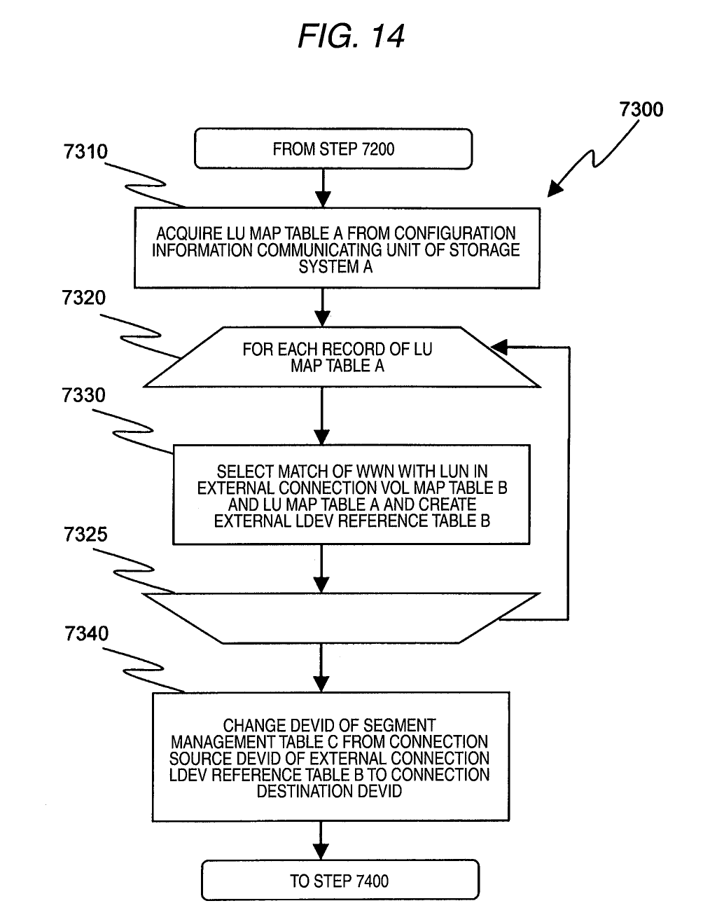

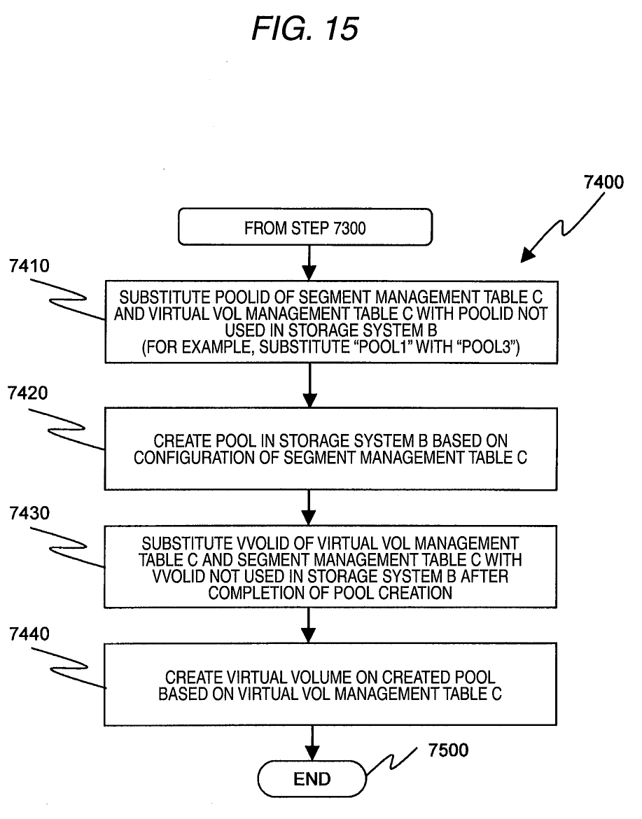

Step 7100 will be described in detail later with reference to FIG. 11. Step 7200 will be described in detail later with reference to FIG. 13. Step 7300 will be described in detail later with reference to FIG. 14. Step 7400 will be described in detail later with reference to FIG. 15.

Prior to the description on the virtual volume migration process shown in FIG. 9, the configuration of storage system A 1000 and storage system B 2000 before and after the virtual volume migration will be described.

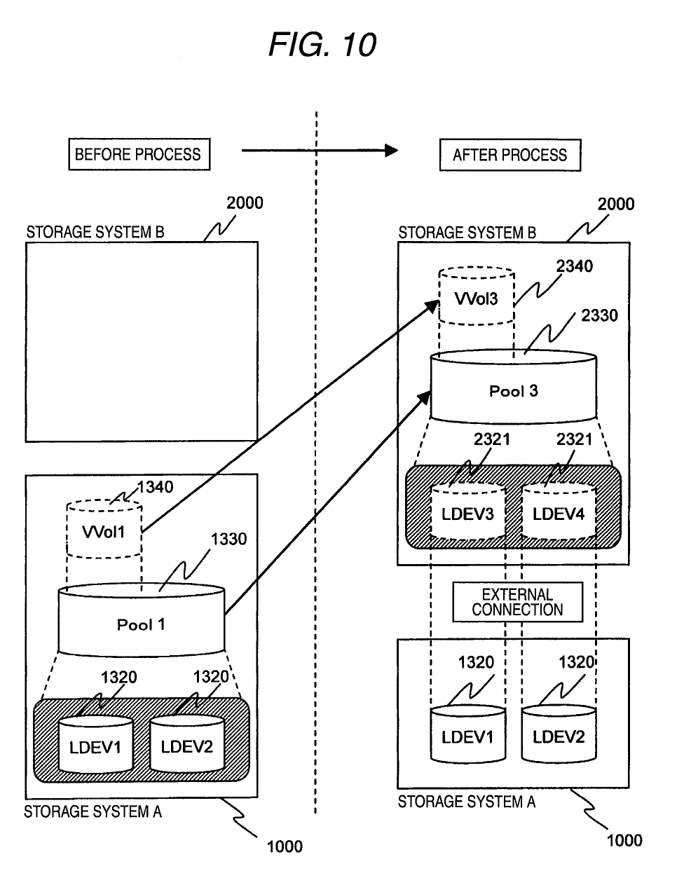

FIG. 10 is an explanatory view showing an outline of the virtual volume migration process according to the first embodiment of the present invention.

Storage system A 1000 before the virtual volume migration process has the logical volume 1320 (its identifier being “LDEV1” and “LDEV2”) and Pool 1330 (its identifier “Pool1”) created from the logical volume 1320. Storage system A 1000 further has the virtual volume 1340 (its identifier being “VVol1”) to which a segment has been allocated from Pool 1330.

Storage system B 2000 after the virtual volume migration process has the logical volume 2321 (its identifier being “LDEV3” and “LDEV4”) input by the external connection and Pool 2330 (its identifier “Pool3”) created from the logical volume 2321.

Storage system B 2000 further has the virtual volume 2340 (its identifier being “VVol3”) to which a segment has been allocated from Pool 2330. Returning to FIG. 9, the outline of the process of virtual Vol migration unit I 2210 of storage system B 2000 will be described.

First, virtual Vol migration unit I 2210 is instructed to move “Pool1” of storage system A 1000 to storage system B 2000 via, for example, the management IF 2010 (Step 7000).

Next, virtual Vol migration unit I 2210 acquires virtual Vol management table A 4200, which is configuration information of the virtual volume 1340, and segment management table A 4300, which is configuration information of Pool 1330, from storage system A 1000 (Step 7100).

Next, virtual Vol migration unit I 2210 provides the external connection processing unit 2240 with an instruction to external connection of the logical volume “LDEV1” and “LDEV2” included in “Pool1” by referring to the acquired segment management table A 4300 (Step 7200).

Then, virtual Vol migration unit I 2210 transforms segment management table A 4300 in order to use the externally connected logical volume “LDEV1” and “LDEV2” in storage system B 2000 (Step 7300). In addition, virtual Vol migration unit 12210 creates the logical volume “LDEV3” and “LDEV4” input by the external connection in storage system B 2000.

Finally, virtual Vol migration unit I 2210 creates “Pool3” and the virtual volume “VVol3” having the same configuration information as “Pool1” and the virtual volume “VVol1”, respectively, of storage system A 1000 before the migration process by virtual Vol management table A 4200 acquired from storage system A 1000 and the transformed segment management table A 4300 (Step 7400) and then the migration process is ended (Step 7500).

In the example shown in FIG. 10, the identifiers of Pool 2330 and virtual volume 2340 of storage system B 2000 after the migration process were transformed into identifier different from the identifiers of Pool 1330 and virtual volume 1340 of storage system A 1000 before the migration process.

If the identifiers of Pool 1330 and virtual volume 1340 of storage system B 2000 do not overlap the identifiers of Pool 1330 and virtual volume 1340 of storage system A 1000, the identifiers of Pool 1330 and virtual volume 1340 of storage system A 1000 before the migration process may be used, without being changed, by storage system B 2000 after the migration process.

In this case, in storage system B 2000 after the migration process, “Pool3” and “VVol3” shown in FIG. 10 may be changed to “Pool1” and “VVol1,” respectively.

If storage system A 1000 has one or more Pools 1330, virtual Vol migration unit I 2210 repeats Steps 7000 to 7400 shown in FIG. 9 for each Pool 1330 and moves all Pools 1330 of storage system A 1000 to storage system B 2000.

According to the above-described series of migration processes, storage system B 2000 can use Pool 2330 and virtual volume 2340 having the same configuration as Pool 1330 and virtual volume 1340 of storage system A 1000, respectively.

In the migration process of the virtual volume 1340, since storage system B 2000 uses a storage region of storage system A 1000 without copying data stored in the storage region of storage system A 1000 to a storage region of storage system B 2000, storage system B 2000 requires no new storage region for data copy.

According to the above-described series of migration processes, unlike simple copy of the virtual volume 1340 of storage system A 1000 to a storage region of storage system B 2000, storage system B 2000 can treat the virtual volume 1340 of storage system A 1000 as the virtual volume 2340 of storage system B 2000 and thus can provide a function using information on allocation of segment to the virtual volume 2340 (for example, function to copy only a portion of the virtual volume 2340 allocated with a segment to another logical volume 2321, etc.)

In the above-described series of migration processes, storage system B 2000 may acquire only the configuration information of segment management table A 4300 and virtual Vol management table A 4200 of storage system A 1000. Accordingly, storage system B 2000 can use the virtual volume of storage system A 1000 much faster than when copying the virtual volume 1340 of storage system A 1000, along with data stored in the logical volume 1320 corresponding to the virtual volume 1340, to a storage region of storage system B 2000.

In the above-described series of migration processes, storage system A 1000, which is a migration source, has only to include the configuration information communicating unit 1240 which transmits the configuration information, and storage system A 1000 does not require an additional special processing unit for migration process. In addition, storage system A 1000 may not have a function to copy the logical volume 1320 to storage system B 2000.

Steps in FIG. 9 will be described in more detail with reference to FIGS. 11 to 15.

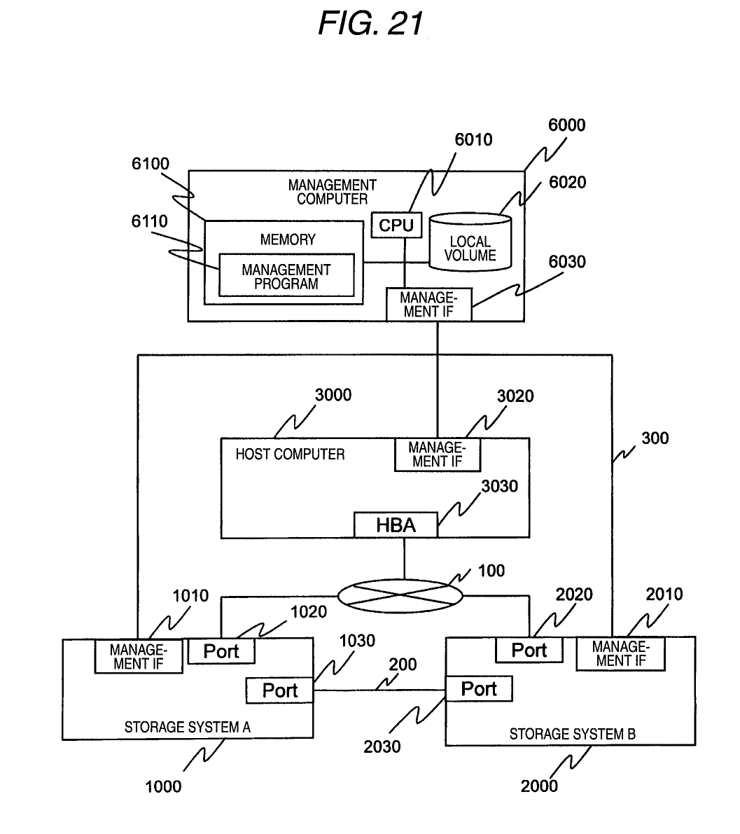

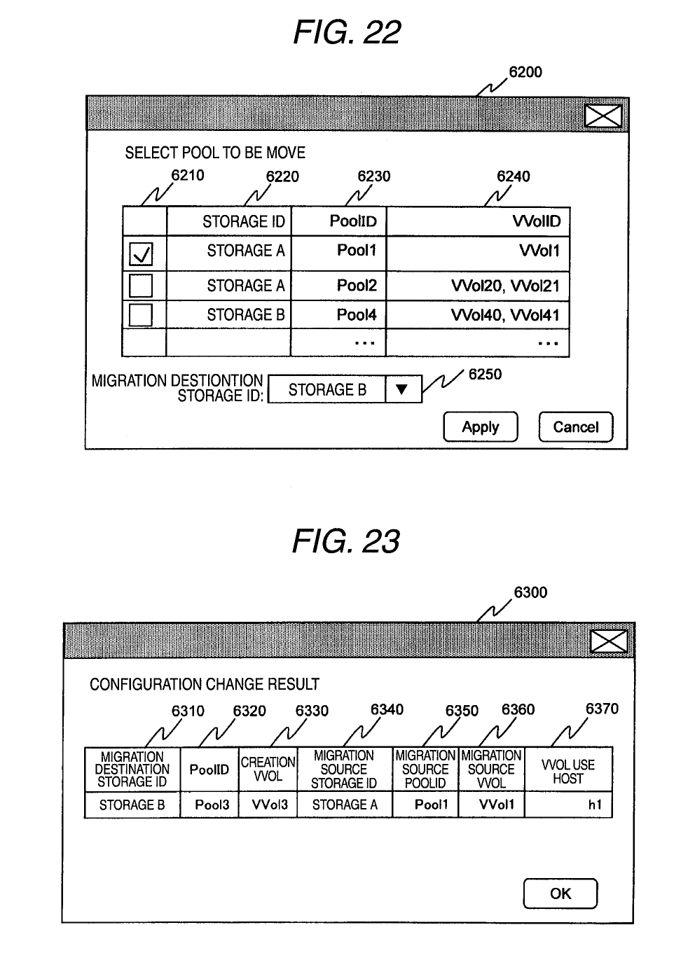

First, at Step 7000, virtual Vol migration unit I 2210 is instructed from the management IF 2010 to move Pool 1330 (its identifier being “Pool1”) of storage system A 1000 and specifies storage system A 1000, which is a migration source, and Pool 1330 of storage system A 1000. A user may instruct migration of Pool using a management console (not shown) of storage system B 2000 or a management screen (see FIG. 22) provided by a management program 6110 of a management computer 6000 shown in FIG. 21, which will be described later. In addition, the “Pool1” migration instruction may be embedded in a string of bytes of data flowing on a network according to a predetermined rule.

Next, Step 7100 of FIG. 9 will be described in detail with reference to FIG. 11.

FIG. 11 is a flow chart showing a process of acquiring configuration information of Pool and a virtual volume according to the first embodiment of the present invention.

Virtual Vol migration unit I 2210 specifies an object of the migration source to be “Pool1” of storage system A 1000 according to Step 7000.

Next, virtual Vol migration unit I 2210 checks whether or not it can communicate with the configuration information communicating unit 1240 of storage system A 1000 (Step 7110).

In addition, storage system B 2000 may communicate with storage system A either via the network 300 such as LAN through the management IF 2010 or via the network 100 such as interconnected SANs through Port 2020.

Hereinafter, an example where the configuration information communicating unit 1240 of storage system A 1000 transmits the configuration information via the management IF 1010 will be described. In addition, for example, if the network 100 is LAN, virtual Vol migration unit I 2210 transmits Ping or the like to the configuration information communicating unit 1240 and determines whether or not the virtual Vol migration unit I 2210 can communicate with storage system A 1000 by checking whether or not there is a response from the configuration information communicating unit 1240.

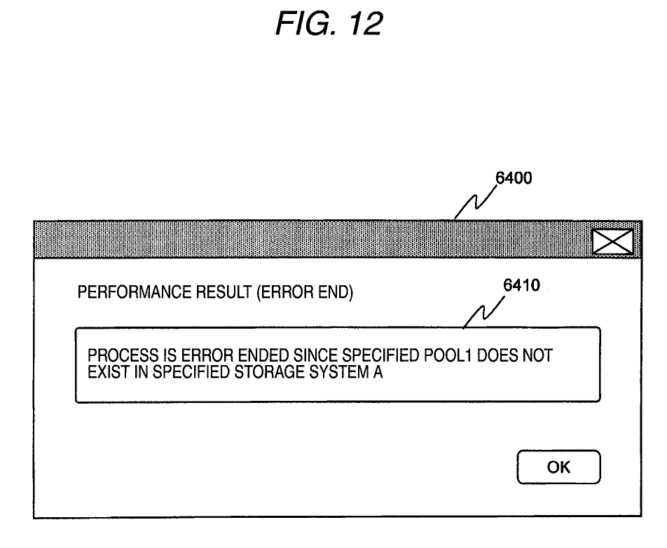

If it is checked at Step 7110 that the communication is impossible, virtual Vol migration unit I 2210 terminates the process (Step 7500). If an output terminal or the like (for example, the management computer 6000 shown in FIG. 21 which will be described later) is connected to the management IF 2010, virtual Vol migration unit I 2210 may inform the output terminal or the like that the process is abnormally terminated (Step 7150). In this case, the output terminal or the like may display an error display screen based on informed errors. An example of display on the error display screen will be described below with reference to FIG. 12.

FIG. 12 is an explanatory view showing an example of an error display screen according to the first embodiment of the present invention.

An error display screen 6400 includes a screen configuration element 6410 indicating the cause of errors, etc. The description returns to FIG. 11.

If it is checked at Step 7110 that the communication is possible, virtual Vol migration unit I 2210 proceeds to Step 7120.

Next, virtual Vol migration unit I 2210 requests the configuration information communicating unit 1240 to transmit virtual Vol management table A 4200, which is the configuration information of virtual volume 1340 of storage system A 1000, and segment management table A 4300, which is the segment management information of Pool, to storage system B 2000.

Upon receiving the request for transmission, the configuration information communicating unit 1240 transmits virtual Vol management table A 4200 and segment management table A 4300 to the virtual Vol migration unit I 2210 via the management IF 1010.

Thus, virtual Vol migration unit I 2210 acquires virtual Vol management table A 4200 and segment management table A 4300 (Step 7120).

In addition, when virtual Vol migration unit I 2210 requests the configuration information communicating unit 1240 to transmit the tables 4200 and 4300, it may designate an identifier of Pool and acquire only a record including the designated identifier of Pool from virtual Vol management table A 4200 and segment management table A 4300.

Next, virtual Vol migration unit I 2210 checks whether or not the acquired segment management table A 4300 includes a record having “Pool1.” (Step 7130)

If it is checked at Step 7130 that the record having “Pool1” is not included in the table 4300, virtual Vol migration unit I 2210 terminates the process (Step 7500).

If the output terminal or the like is connected to the management IF 2010, virtual Vol migration unit I 2210 may inform the output terminal or the like that Pool 1330 with the designated identifier does not exist in storage system A 1000 (Step 7150) and the output terminal or the like may display the reason of the informed termination.

If it is checked at Step 7130 that the record having “Pool1” is included in the table 4300, virtual Vol migration unit I 2210 proceeds to Step 7140.

Next, virtual Vol migration unit I 2210 extracts only the record with “Pool1” from the acquired virtual Vol management table A 4200 and segment management table A 4300 and stores tables created by the extracted record in the memory 2200 of storage system B 2000, as virtual Vol management table C 5700 and segment management table C 5800 (Step 7140).

Virtual Vol management table C 5700 and segment management table C 5800 have the same configuration as virtual Vol management table A 4200 and segment management table A 4300 shown in FIGS. 6 and 7, respectively.

Step 7140 is performed when virtual Vol migration unit I 2210 determines the identifier of Pool described in the record for each record of each management table and describes the record with “Pool1” in virtual Vol management table C 5700 or segment management table C 5800.

Virtual Vol migration unit I 2210 creates virtual Vol management table C 5700 or segment management table C 5800 and then proceeds to Step 7200. Since virtual Vol migration unit I 2210 does not use the acquired virtual Vol management table A 4200 and segment management table A 4300 after Step 7200, virtual Vol management table A 4200 and segment management table A 4300 may be deleted from the memory 2200.

At Step 7120, virtual Vol migration unit I 2210 may acquire only the record with “Pool1” from virtual Vol management table A 4200 and segment management table A 4300 and set the acquired record as virtual Vol management table C 5700 and segment management table C 5800.

Step 7140 is not necessarily required, and thus virtual Vol migration unit I 2210 may use virtual Vol management table A 4200 and segment management table A 4300 acquired from storage system A 1000, as they are, and then proceed to the subsequent step.

Next, Step 7200 of FIG. 9 will be described in detail with reference to FIG. 13.

FIG. 13 is a flow chart showing a process of connecting a logical volume to the outside according to the first embodiment of the present invention.

At Step 7200 (including Steps 7210 to 7225), the logical volume “LDEV1” and “LDEV2” included in “Pool1” is externally connected to storage system B 2000 after virtual Vol migration unit I 2210 acquires the configuration information of “Pool” of storage system A 1000.

In addition, before starting Step 7200, virtual Vol migration unit I 2210 may delete “Pool1” and “VVol1” created in storage system A 1000, as necessary, for external connection process of the logical volume “LDEV1” and “LDEV2” included in “Pool1” of storage system A 1000.

In this case, virtual Vol migration unit I 2210 instructs the segment processing unit 1230 to delete “Pool1” created by “LDEV1” and “LDEV2” and instructs the virtual Vol processing unit 1220 to delete “VVol1” allocated with a segment of “Pool1.” The deletion instruction may be made through the management IF 2010.

In addition, when “Pool1” is deleted, in order to prevent data stored in the logical volume “LDEV1” and “LDEV2” included in the deleted “Pool1” from being changed, virtual Vol migration unit I 2210 may disallow data writing from the host computer 3000 into “LDEV1” and “LDEV2.” In this case, virtual Vol migration unit I 2210 may instructs the LU map processing unit 1210 of storage system A 1000 to set writing disallowance.

First, virtual Vol migration unit I 2210 checks whether or not there exists WWN of Port of storage system A 1000 connected via the network 100 such as SAN by referring to interstorage path table B 5400 of storage system B 2000 (Step 7210).

If it is checked at Step 7210 that there exists no corresponding WWN, virtual Vol migration unit I 2210 terminates the process (Step 7500). If the output terminal or the like is connected to the management IF 2010 of storage system B 2000, virtual Vol migration unit I 2210 may inform the output terminal or the like that the process is terminated since there exists no storage system A 1000 connected to storage system B 2000 and may instruct the output terminal or the like to display the informed error (Step 7260).

If it is checked at Step 7210 that there exists any corresponding WWN (that is, there exists storage system A 1000 which can communicate with storage system B 2000 via the network 100 such as SAN), virtual Vol migration unit I 2210 proceeds to Step 7220.

Next, virtual Vol migration unit I 2210 repeats Steps 7230 to 7250 for all described segments by referring to segment management table C 5800 acquired from storage system A 1000 at Step 7140 (Step 7220).

After performing Steps 7230 to 7250 for all segments, virtual Vol migration unit I 2210 proceeds to Step 7300 (Step 7220).

The description returns to Step 7230.

By referring to segment management table C 5800, virtual Vol migration unit I 2210 checks DEVID 4330 corresponding to segment ID 4320 and checks whether or not the logical volume 1320 (for example, “LDEV1” or “LDEV2”) indicated by DEVID 4330 is externally connected (Step 7230).

If it is checked at Step 7230 that the logical volume 1320 is not externally connected, virtual Vol migration unit 12210 proceeds to Step 7240.

If it is checked at Step 7230 that the logical volume 1320 has been already externally connected, virtual Vol migration unit I 2210 proceeds to Step 7225 and performs Steps 7230 to 7250 for the logical volume 1320 corresponding to another segment ID 4320.

Virtual Vol migration unit I 2210 may determine whether or not the logical volume 1320 is externally connected, based on DEVID of the logical volume 1320 instructed to be externally connected at Step 7220 or based on the logical volume 1320 described in LU map table A 4100 acquired from the configuration information communicating unit 1240.

Next, Step 7240 will be described.

It was determined at Step 7230 that the logical volume 1320 (for example, “LDEV1”) corresponding to segment ID 4320) has not been already externally connected.

Accordingly, by referring to interstorage path table B 5400, virtual Vol migration unit I 2210 checks a connection destination WWN 5430 (storage system A 1000) connected to a connection source WWN 5410 (storage system B 2000).

For example, here, Port of storage system B 2000 with “WWN4” is connected to Port of storage system A 1000 with “WWN3.”

Virtual Vol migration unit I 2210 instructs the LU map processing unit 1210 of storage system A 1000 to LU-map the logical volume 1320 (for example, “LDEV1”) corresponding to segment ID 4320, which was determined that the external connection has not been completed, to the logical unit 1350 (for example, “LUN1”) via Port of storage system A 1000 with “WWN3” (Step 7240).

After receiving the LU mapping instruction, the LU map processing unit 1210 makes the instructed logical volume “LDEV1” corresponding to Port with “WWN3” designated by virtual Vol migration unit I 2210, as the logical unit 1350 which is “LUN1.”

A LUN number may be any number which does not overlap the LUN number already allocated to “WWN3” of storage system B 2000. For example, the smallest number of numbers which do not overlap the existing LUN numbers may be selected.

The LU map processing unit 1210 reflects a result of the LU mapping in LU map table A 4100.

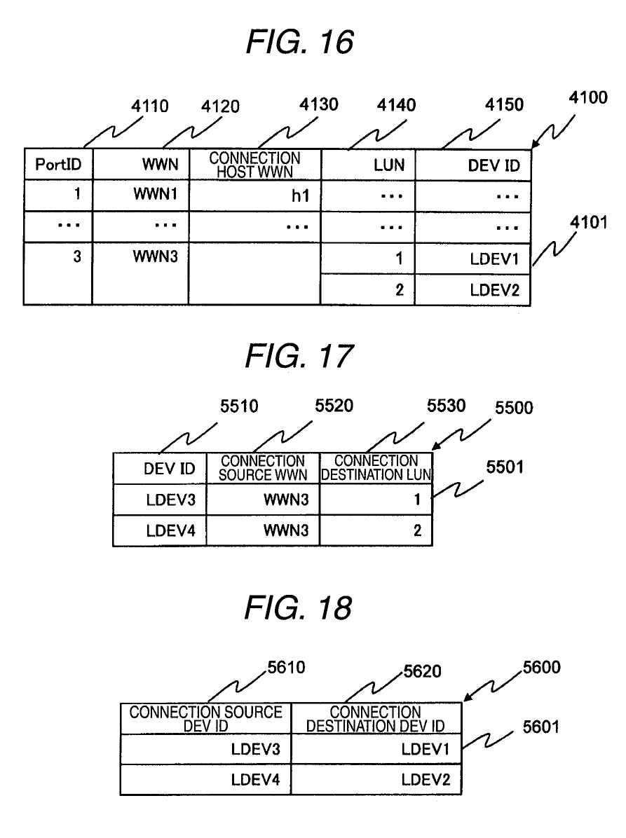

Now, LU map table A 4100 updated after completing the LU mapping will be described with reference to FIG. 16.

FIG. 16 is an explanatory view showing an example of configuration of LU map table A at the time of external connection of a logical volume according to the first embodiment of the present invention.

In LU map table A 4100 shown in FIG. 16, the logical volume “LDEV1” and “LDEV2” included in “Pool1” is LU-mapped onto Port with “WWN3”, as the logical unit 1350 of “LUN1” and “LUN2,” respectively.

LU map table A 4100 shown in FIG. 16 is different from LU map table A 4100 shown in FIG. 5 in that a row “WWN3” is added in the former.

Returning to FIG. 13, Step 7250 where the LU-mapped logical volume “LDEV1” and “LDEV2” are externally connected will be described.

Virtual Vol migration unit I 2210 instructs the external connection processing unit 2240 to externally connect “LDEV1” LU-mapped onto “LUN1” to Port of storage system A 1000 which is allocated with “WWN3” in Step 7240. Likewise, virtual Vol migration unit I 2210 instructs the external connection processing unit 2240 to externally connect “LDEV2” LU-mapped onto “LUN2.” (Step 7250)

Next, the above-instructed external connection processing unit 2240 allocates a new identifier “LDEV3” (or “LDEV4”) for use in storage system B 2000 to the logical volume “LDEV1” (or “LDEV2”) LU-mapped onto Port of storage system A 1000 with “WWN3” and creates external connection Vol map table B 5500 which will be described below with reference to FIG. 17. Thus, storage system B 2000 can provide the logical volume 1320 of storage system A 1000 to the host computer 3000 (or the management computer or the like), as the logical volume 2321 of storage system B 2000.

FIG. 17 is an explanatory view showing an example of configuration of external connection Vol map table B at the time of external connection of a logical volume according to the first embodiment of the present invention.

External connection Vol map table B 5500 includes DEVID 5510, connection destination WWN 5520 and connection destination LUN 5530. In the first embodiment, a connection destination of external connection is storage system A 1000 and a connection source is storage system B 2000.

DEVID 5510 is an identifier given to the logical volume 2321 externally connected to the connection source (in this example, storage system B 2000). Connection destination WWN 5520 is WWN of the connection destination (in this example, storage system A 1000) having the externally connected actual logical volume 1320. Connection destination LUN 5530 is an identifier of the logical unit 1350 LU-mapped onto the externally connected logical volume 1320 in the connection destination (storage system A 1000).

The description returns to FIG. 13.

Virtual Vol migration unit I 2210 performs Step 7240 (LU mapping process) and Step 7250 (external connection process) for all logical volumes 1320 included in “Pool1” and then proceeds to Step 7300. Step 7250 may be performed after Step 7240 is performed for all logical volumes 1320 included in “Pool1”, that is, after the LU mapping is completed.

Next, Step 7300 will be described in detail with reference to FIG. 14.

FIG. 14 is a flow chart showing a process of transforming configuration information of Pool and a virtual volume according to the first embodiment of the present invention.

Step 7300 (including Steps 7310 to 7340) is a transforming process performed so that virtual Vol migration unit I 2210 can use virtual Vol management table C 5700 and segment management table C 5800, which are acquired from storage system A 1000, in storage system B 2000.

Virtual Vol migration unit I 2210 acquires LU map table A 4100 from the configuration information communicating unit 1240 of storage system A 1000 after external connection of all logical volumes (in this example, “LDEV1” and “LDEV2”) included in “Pool1.” (Step 7310)

In this case, LU map table A 4100 is a table including the information shown in FIG. 16, not FIG. 5. Virtual Vol migration unit I 2210 does not necessarily acquire all records included in LU map table A 4100, but may acquire only a record including WWN (for example, “WWN3”) designated as connection destination WWN of external connection at Step 7250.

Next, virtual Vol migration unit I 2210 repeats Step 7330 for the record including the designated WWN (for example, “WWN3”) of LU map table A4100 acquired at Step 7310 (Step 7320) and proceeds to Step 7340 after completing Step 7330 for all records (Step 7325).

Virtual Vol migration unit I 2210 creates external connection LDEV reference table B 5600 (see FIG. 18) by referring to external connection Vol map table B 5500 created at Step 7250 and LU map table A 4100 acquired at Step 7310 (Step 7330).

Next, external connection LDEV reference table B 5600 will be described with reference to FIG. 18.

FIG. 18 is an explanatory view showing an example of configuration of an external connection LDEV reference table at the time of external connection of a logical volume according to the first embodiment of the present invention.

External connection LDEV reference table B 5600 includes connection source DEVID 5610 and connection destination DEVID 5620.

Connection source DEVID 5610 is an identifier by which storage system B 2000 is externally connected to the logical volume 1320 of storage system A 1000 and which is given to the logical volume 2321 input in storage system B2000. Connection destination DEVID 5620 is an identifier of the logical volume 1320 of the externally connected storage system A 1000.

For example, virtual Vol migration unit I 2210 specifies a record 4101 with WWN as “WWN3”, LUN as “1” and DEVID as “LDEV1” by referring to LU map table A 4100 shown in FIG. 16 (Step 7320).

Next, virtual Vol migration unit I 2210 specifies a record having the same values as WWN (in this example, “WWN3”) and LUN (in this example, “LUN1”) of the record 4101 by referring to external connection Vol map table B 5500 shown in FIG. 17.

In this example, connection destination WWN 5520 and connection destination LUN 5530 of a record 5501 match WWN and LUN of the record 4101, respectively.

Accordingly, virtual Vol migration unit I 2210 describes “LDEV3” shown in DEVID 5510 of the record 5501 in connection source DEVID 5610 of external connection LDEV reference table B 5600 shown in FIG. 18 and describes “LDEV1” shown in DEVID of the record 4101 in connection destination DEVID 5620.

Thus, a record 5601 is added to external connection LDEV reference table B 5600.

According to the above processes, virtual Vol migration unit I 2210 creates external connection LDEV reference table B 5600 describing a correspondence relation between the identifier of the externally connected logical volume 1320 of the connection destination and the identifier of the logical volume 2321 input by the connection source (Step 7330 shown in FIG. 14).

The description returns to FIG. 14. After creating external connection LDEV reference table B 5600, virtual Vol migration unit I 2210 proceeds to Step 7340.

Virtual Vol migration unit I 2210 rewrites DEVID 4330 of segment management table C 5800 acquired from storage system A 1000 with reference to external connection LDEV reference table B 5600 created by Step 7330.

That is, “LDEV1” (corresponding to connection destination DEVID 5620 shown in the record 5601 of FIG. 18) described in DEVID 4330 is substituted with “LDEV3” (corresponding to connection source DEVID 5610 shown in the record 5601 of FIG. 18) (Step 7340).

Virtual Vol migration unit I 2210 performs the above substitution process for all records of segment management table C 5800 acquired from storage system A 1000.

If virtual Vol migration unit I 2210 is not segment management table C 5800 but uses segment management table A 4300 acquired from storage system A 1000, as it is, virtual Vol migration unit I 2210 may perform the substitution process for only a record with the identifier of Pool as “Pool1.”

For example, in segment management table A 4300 shown in FIG. 6, PoolID 4310 is “Pool1”, and as for the record 4301 recorded in DEVID 4330 as “LDEV1,” “LDEV1,” which is connection destination DEVID 5620, is substituted to “LDEV3” of connection source DEVID 5610, by corresponding relation of record 5601 of external connection LDEV reference table B 5600 shown in FIG. 18.

After completing the DEVID substitution process for all segments included in “Pool1,” that is, all records described with “Pool1” of segment management table C 5800, virtual Vol migration unit I 2210 proceeds to Step 7400.

Next, Step 7400 shown in FIG. 9 will be described in detail with reference to FIG. 15.

FIG. 15 is a flow chart showing a process of creating Pool and a virtual volume in storage system B according to the first embodiment of the present invention.

At Step 7400 (including Steps 7410 to 7440), virtual Vol migration unit I 2210 actually creates Pool 2330 in storage system B 2000 by referring to virtual Vol management table C 5700 and segment management table C 5800.

In order to prevent an identifier of Pool newly created based on virtual Vol management table C 5700 and segment management table C from overlapping the identifier of Pool of storage system B 2000, virtual Vol migration unit I 2210 substitutes the identifier of Pool 1330 moved from storage system A 1000 with another identifier (Step 7410).

For example, virtual Vol migration unit I 2210 substitutes “Pool1” with “Pool3,” which is an identifier not used in storage system B 2000, for each record of virtual Vol management table C 5700 and segment management table C 5800 of storage system B 2000, which are acquired from storage system A 1000.

In addition, virtual Vol migration unit I 2210 can confirm the identifier of Pool already used in storage system B 2000 by referring to virtual Vol management table B 5200 and segment management table B 5300 of storage system B 2000.

If “Pool1” is not used in storage system B 2000, it is preferable that virtual Vol migration unit I 2210 creates Pool using “Pool1” as it is without substituting the identifier of Pool. In addition, virtual Vol migration unit I 2210 may store the identifier of Pool before and after the substitution and inform the output terminal or the like (for example, the management computer 6000 shown in FIG. 21, which will be described later) of a substitution result.

In addition, virtual Vol migration unit I 2210 may perform a migration process of Pool if there is no substitution process at Step 7410, that is, if the identifier of Pool is not changed, and may terminate the migration process of Pool if there is any substitution process, for example, if the identifier of Pool is changed from “Pool1” to “Pool3.” If the output terminal or the like is connected to the management IF 2010, virtual Vol migration unit I 2210 may inform the output terminal or the like of the cause of termination of the Pool migration process. If the identifier of Pool is changed, virtual Vol migration unit I 2210 may display a confirmation on execution on the output terminal or the like.

Next, by referring to segment management table C 5800 with the Pool identifier substituted with “Pool3” at Step 7410 after being acquired from storage system A 1000, virtual Vol migration unit I 2210 instructs the segment processing unit 2230 to create Pool with “Pool3” in storage system B 2000.

Next, the instructed segment processing unit 2230 adds a record of segment management table C 5800 with the substituted Pool identifier, which is acquired from storage system A 1000, to segment management table B 5300 of storage system B 2000.

Then, the segment processing unit 2230 creates Pool with its identifier as “Pool3” based on segment management table B 5300 (Step 7420).

In the Pool creating process, if a write event such as formatting occurs in the logical volume “LDEV3” and “LDEV4” included in “Pool3,” virtual Vol migration unit I 2210 instructs the segment processing unit 2230 not to perform a writing process. If storage system B 2000 has no segment management table C 5800 and uses segment management table A 4300 acquired from storage system A 1000, as it is, the segment processing unit 2230 may perform Step 7420 for only a record with “Pool3” (the identifier of Pool of segment management table A 4300 being substituted at Step 7410).

Now, segment management table B 5300 of storage system B 2000 after the segment processing unit 2230 performs Step 7420 will be described with reference to FIG. 19.

FIG. 19 is an explanatory view showing an example of configuration of segment management table B according to the first embodiment of the present invention.

In segment management table B 5300, Pool includes PoolID 5310, segment ID 5320, DEVID 5330, initiation LBA 5340, segment size 5350 and VVolID 5360.

Segment management table B 5300 is different from segment management table A 4300 shown in FIG. 6 in that values of PoolID 5310 and DEVID 5330 are substituted.

In addition, at Step 7430 which will be described later, if an identifier of virtual Vol is transformed, VVolID 5360 is varied.

Returning to FIG. 15, Step 7430 will be described. In order to prevent an identifier of a newly created virtual volume from overlapping the identifier of the virtual volume of storage system B 2000, virtual Vol migration unit I 2210 substitutes the identifier of the virtual volume 1340 moved from storage system A 1000 with another identifier (Step 7430).

Specifically, virtual Vol migration unit I 2210 substitutes an identifier of a virtual volume of each record of virtual Vol management table C 5700 of storage system B 2000, which is acquired form storage system A 1000, with an identifier not used in storage system B 2000. In addition, if identifiers of a plurality of virtual volumes are described in virtual Vol management table C 5700 acquired from storage system A 1000, virtual Vol migration unit I 2210 provides different identifiers.

Then, virtual Vol migration unit I 2210 uses a relation between PoolID, segment ID and VVolID of the substituted virtual Vol management table C 5700 to substitute VVolID of segment management table C 5800.

In addition, virtual Vol migration unit I 2210 can confirm an identifier not used in storage system B 2000 by referring to virtual Vol management table B 5200 of storage system B 2000.

For example, if “VVol1” is included in virtual Vol management table C 5700 acquired from storage system A 1000, virtual Vol migration unit I 2210 substitutes “VVol1” with “VVol3” yet not used in storage system B 2000.

If “VVol2” other than “VVol1” is included in the table C 5700, virtual Vol migration unit I 2210 substitutes “VVol2” with “VVol4,” which is not used in storage system B 2000 and is different from “VVol3.” (Step 7430)

Then, virtual Vol migration unit I 2210 can know that segment ID “001” with PoolID as “Pool3” belongs to VVolID “VVol3” by referring to the substituted virtual management table C 5700. Thus, virtual Vol migration unit I 2210 changes VVolID corresponding to segment ID “001” of PoolID “Pool3” of segment management table C 5800 from “VVol1” to “VVol3.”

If storage system B 2000 has no virtual Vol management table C 5700 and uses virtual Vol management table A 4200 acquired from storage system A 1000, as it is, virtual Vol migration unit I 2210 substitutes an identifier for only a virtual volume with a Pool identifier as “Pool3” (the identifier of Pool of virtual Vol management table A 4200 being substituted at Step 7410).

Like notification of the process termination at Step 7410, if at least one identifier of a virtual volume is changed, virtual Vol migration unit I 2210 may inform the output terminal or the like of an error and terminate the virtual volume creating process.

In addition, virtual Vol migration unit I 2210 may store the identifier of virtual volume before and after the substitution and inform the output terminal or the like of a result of substitution of the identifier of the virtual volume.

Next, by referring to virtual Vol management table C 5700 with the substituted virtual volume identifier at Step 7430 after being acquired from storage system A 1000, virtual Vol migration unit I 2210 instructs the virtual Vol processing unit 2220 to create all virtual volumes allocated with segment of “Pool3.”

The instructed virtual Vol processing unit 2220 adds all records with “Pool3” in virtual Vol management table C 5700 to virtual Vol management table B 5200 of storage system B 2000.

The virtual Vol processing unit 2220 creates a virtual volume allocated with a segment of Pool with “Pool3” based on virtual Vol management table B 5200 (Step 7440).

If storage system B 2000 has no virtual Vol management table C 5700 and uses virtual Vol management table A 4200 acquired from storage system A 1000, as it is, the virtual Vol processing unit 2220 may perform Step 7440 for only the record with the Pool identifier as “Pool3.”

Now, virtual Vol management table B 5200 of storage system B 2000 after the virtual Vol processing unit 2220 performs Step 7440 will be described with reference to FIG. 20.

FIG. 20 is an explanatory view showing an example of configuration of virtual Vol management table B according to the first embodiment of the present invention.

Virtual Vol management table B 5200 includes VVolID 5210, size 5220, initiation VLBA 5230, PoolID 5240, segment ID 5250 and segment size 5260. Virtual Vol management table B 5200 is different from virtual Vol management table A 4200 shown in FIG. 7 in that an identifier is substituted with VVolID 5210 and PoolID 5240.

As described above, according to the first embodiment, storage system B 2000 can succeed to a correspondence relation between logical volumes and segments and a correspondence relation between one virtual volume and another virtual volume in storage system A 1000.

In addition, storage system B 2000 can provide the virtual volumes equal to the virtual volumes of storage system A 1000 without copying data of storage system A 1000 to the host computer.

In addition, the computer system of the first embodiment may include the host computer 3000 and the management computer that manages storage system A 1000 and storage system B 2000.

FIG. 21 is a block diagram showing a configuration of the computer system according to a modification of the first embodiment of the present invention.

The computer system shown in FIG. 21 includes the management computer 6000 in addition to storage system A 1000, storage system B 2000 and the host computer 3000 shown in FIG. 1.

The management computer 6000 is a computer such as a workstation including a CPU 6010, a local volume 6020, a memory 6100 and a management IF 6030.

The memory 6100 stores a management program 6110. The management program 6110 (corresponding to the task program 3110 in FIG. 1) manages the storage system and the host computer 3000 via the management IF 6030.

The CPU 6010, local volume 6020 and management IF 6030 of the management computer 6000 are the same as the CPU 3040, local volume 3010 and management IF 3020 of the host computer 3000, respectively, and the memory 6100, which is a temporary storage region, stores the management program 6110 for management of volume configuration of the storage system. The management computer 6000 may further include an output device (not shown) such as a display and an input device (not shown) such as a keyboard.

In addition to the general management function of the storage system, the management program 6110 may perform Steps 7000 to 7400 shown in FIG. 9 via the management IF 6030, in place of the controller 2010 of storage system B.

In this case, storage system B 2000 may not have virtual Vol migration unit I 2210, but may instead have the controller 2100 including a processing unit informing the management computer 6000 of the configuration information of storage system B 2000.

The management program 6110 instructs migration of Pool set in the management IF of the storage system of the migration destination based on user's setting shown in FIG. 22 which will be described later (Step 7000 in FIG. 9).

Next, the management program 6110 acquires segment management table A 4300 and virtual Vol management table A 4200 from the configuration information communicating unit 1240 of storage system A1000 which is a migration source storage system (Step 7100 in FIG. 9).

Next, by referring to the acquired segment management table A 4300, the management program 6110 performs LU mapping of the logical volume 1320 creating Pool of storage system A 1000 and instructs the external connection processing unit 2240 to externally connect the LU-mapped logical volume 1320 to storage system B 2000 which is a migration destination (Step 7300 in FIG. 9).

Next, after acquiring LU map table A 4100 from storage system A 1000 and external connection Vol map table B 5500 from storage system B 2000, by referring to LU map table A 4100 and external connection Vol map table B 5500, the management program 6110 transforms segment management table A 4300 and virtual Vol management table A 4200 acquired from storage system A 1000 (Step 7300 in FIG. 9).

In addition, based on the transformed management tables, the management program 6110 instructs the virtual Vol processing unit 2220 of storage system B 2000 to create Pool 2330 having the same configuration and data as storage system A 1000 and instructs the segment processing unit 2230 to create the virtual volume 2340 (Step 7400 in FIG. 9).

The details of the above-described processes are the same as the processes shown in FIGS. 11, 13, 14 and 15.

In addition, if information of migration source storage system A 1000 and Pool 1330 is specified at Step 7000 in FIG. 9, by referring to connection host WWN 4130 of LU map table A 4100, the management program 6110 may make offline the host computer 3000 using the virtual volume 1340 created by segments of the specified Pool 1330.

In addition, after acquiring LU map table A 4100 showing a correspondence relation between the host computer 3000 and the logical volume 1320 before the offline process and performing Step 7400, the management program 6110 may allocate the moved virtual volume 2340 to the host computer 3000, which has used the virtual volume 1340 of storage system A 1000, to enable data input/output from the task program 3110.

In addition, in order for a user to set a migration source storage system and Pool, the management program 6110 may have a function of displaying the setting screen shown in FIG. 22 on an output device.

FIG. 22 is an explanatory view showing an example of a screen for setting Pool migration according to the first embodiment of the present invention.

A setting screen 6200 includes a selection portion 6210, storage ID 6220, PoolID 6230, VVolID 6240, migration destination storage ID 6250, an apply button and a cancel button.

Storage ID 6220 is an identifier of a migration source storage system. PoolID 6230 is an identifier of Pool to be moved. The selection portion 6210 is, for example, check boxes to specify the migration source storage system and Pool to be moved.

The setting screen 6200 may include VVolID 6240 as a screen component to indicate an identifier of a virtual volume using Pool. Migration destination storage ID 6250 is a screen component to specify an identifier of the migration destination storage system.

If storage system B 2000 or the like has a management console (not shown) through the management IF 2010, a management console setting screen 6200 may be displayed. In this case, the screen component to indicate migration destination storage ID 6250 is unnecessary.

In addition, the management program 6110 may have a function of displaying a screen to indicate a, result of migration of Pool and a virtual volume on an output device after Step 7400.

FIG. 23 is an explanatory view showing an example of a screen for displaying a migration result according to the first embodiment of the present invention.

A screen 6300 may include migration destination storage ID 6310, PoolID 6320, creation VVol 6330, migration source storage ID 6340, migration source PoolID 6350, migration source VVol 6360 and VVol use host 6370 for operation after migration.

An example of the screen 6300 shown in FIG. 23 shows a result of migration of “VVol1” using “Pool1 created in storage system A 1000 to “VVol3” using “Pool3” created in storage system B 2000.

In addition, the screen 6300 may include a screen component of VVol use host 6370 to indicate which host computer has used a virtual volume in a migration source storage system. An example of the screen 6300 shows that a host computer “h1” has used “VVol1” before migration.

If there exists no virtual volume in the migration source storage system, the screen 6300 may not indicate creation VVol 6330. If there exists no host computer which has used VVol, the screen 6300 may not indicate VVol use host 6370.

In addition, by storing an identifier of Pool and an identifier of a virtual volume before and after the substitution at Step 7300, the management program 6110 can indicate a correspondence relation between PoolID 6320 and migration source PoolID 6350 and a correspondence relation between VVol 6330 and migration source VVol 6360.

In addition, if storage system B 2000 or the like has a management console (not shown) through the management IF 2010, the management console may display the screen 6300.

### Second Embodiment

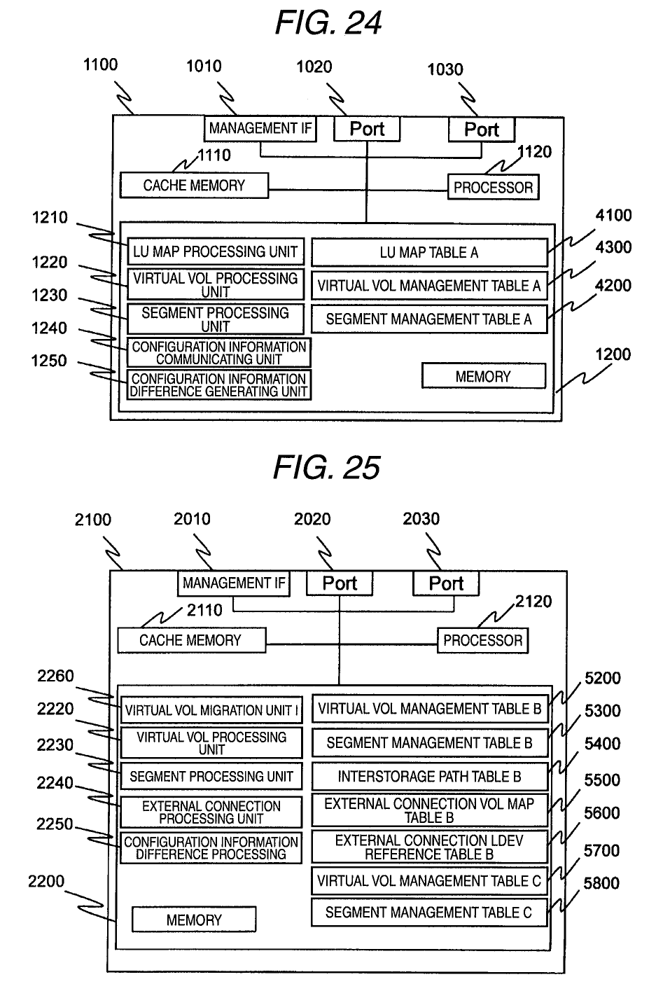

Hereinafter, a second embodiment of the present invention will be described with reference to FIGS. 24 to 27.

In the first embodiment, if the amount of data of segment management table A 4300 and virtual Vol management table A 4200 of storage system A 1000 is large, there is a possibility that much time is spent from the migration instruction at Step 7000 to the migration completion at Step 7400.

For the purpose of avoiding this possibility, in the second embodiment, storage system B 2000 acquires segment management table A 4300 and virtual Vol management table A 4200 of storage system A 1000 in advance and storage system A 1000 properly transmits differential data of the two tables to storage system B 2000. Thus, storage system B 2000 always has tables having the same contents as the two tables of storage system A 1000.

With the configuration of the second embodiment, it is possible to minimize the amount of data of a copy into segment management table B 5300 and virtual Vol management table B 5200 which occurs by the migration instruction and reduce time taken until the migration completion.

A computer system of the second embodiment has the same configuration as the computer system of the first embodiment shown in FIG. 1.

Hereinafter, a difference between the second embodiment and the first embodiment will be described.

FIGS. 24 and 25 are explanatory views showing configuration of controllers of storage system A and storage system B, respectively, according to the second embodiment of the present invention.

The controller 1100 of storage system A 1000 stores in the memory 1200 a program to implement a configuration information difference generating unit 1250 in addition to the components of the first embodiment shown in FIG. 2.

The controller 2100 of storage system B 2000 stores in the memory 2200 a program to implement a configuration information difference processing unit 2250 and virtual Vol migration unit II 2260 different from virtual Vol migration unit I 2210, in addition to the components of the first embodiment shown in FIG. 3.

The configuration information difference generating unit 1250 monitors virtual Vol management table A 4200 and segment management table A 4300, and if the two tables are updated, transmits differential data to the configuration information difference processing unit 2250 of storage system B 2000.

Upon receiving the differential data produced by the update, the configuration information difference processing unit 2250 updates virtual Vol management table C 5700 and segment management table C 5800 of storage system B 2000, which are acquired from storage system A 1000 in advance.

Virtual Vol management table A 4200 requires new allocation of a segment due to data write or the like from the host computer 3000 and is updated when a new virtual volume is created, etc. Segment management table A 4300 is updated when a logical volume is added to Pool, when a segment is allocated to a virtual Vol, etc.

The configuration information difference generating unit 1250 generates match check data A (not shown) created from differential data and transmits the created match check data A, along with the differential data, to the configuration information difference processing unit 2250.

Upon receiving the differential data added with the match check data A (configuration information), the configuration information difference processing unit 2250 creates match check data B (not shown) from the received differential data in the same way as the configuration information difference generating unit 1250.

The configuration information difference processing unit 2250 compares match check data A transmitted from the configuration information difference generating unit 1250 with the match check data B. If match check data A is different from match check data B, the configuration information difference processing unit 2250 stops copy of the differential data and requests the configuration information difference generating unit 1250 to again send the differential data.

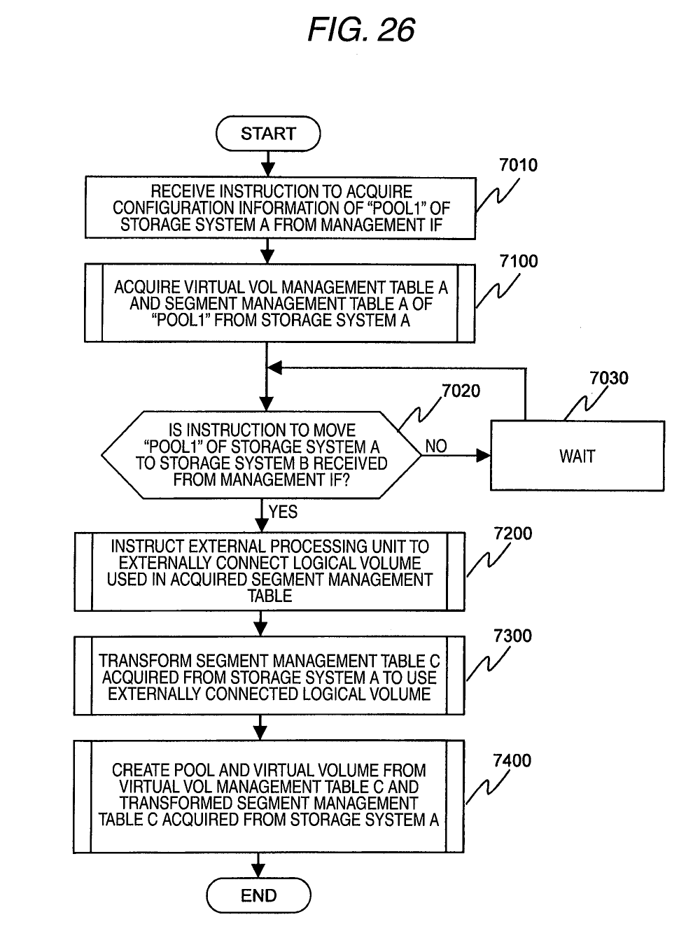

FIG. 26 is a flow chart showing a process of virtual Vol migration unit II according to the second embodiment of the present invention.

The process of virtual Vol migration unit II 2260 shown in FIG. 26 is different from the process of virtual Vol migration unit I 2210 of the first embodiment shown in FIG. 9 in that Step 7000 is changed to Step 7010, and Steps 7020 and 7030 are added.

First, virtual Vol migration unit II 2260 receives from the management IF an instruction that storage system B 2000 acquires the configuration information of storage system A 1000 in advance (Step 7010). Next, after acquiring the configuration information (Step 7100), virtual Vol migration unit II 2260 determines whether or not it is instructed by the management IF to actually move Pool and a virtual volume (Step 7020).

If it is determined at Step 7020 that it is not instructed to do so, virtual Vol migration unit II 2260 waits an instruction from the management IF (Step 7030).

While virtual Vol migration unit II 2260 is waiting (Step 7030), the configuration information difference processing unit 2250 matches virtual Vol management table C 5700 and segment management table C 5800 of storage system B 2000, which are acquired form storage system A 1000, to virtual Vol management table A 4200 and segment management table A 4300 of storage system A 1000, respectively.

That is, the configuration information difference processing unit 2250 updates the configuration information of virtual Vol management table C 5700 and segment management table C 5800 based on the differential data of virtual Vol management table A 4200 and segment management table A 4300 and matches identifiers of Pool specified in all of the tables.

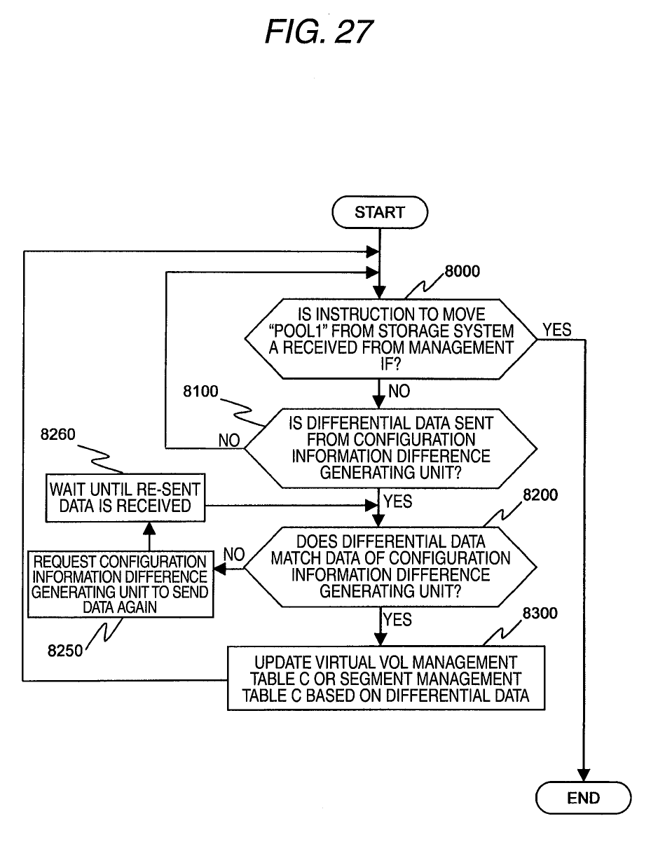

If it is determined at Step 7020 that virtual Vol migration unit II 2260 is instructed to do so, virtual Vol migration unit II 2260 proceeds to Step 7200. To begin with, with regard to the determination at Step 7020, a process of update of the configuration information by the configuration information difference processing unit 2250 will be described with reference to FIG. 27.

FIG. 27 is a flow chart showing a process of the configuration information difference processing unit according to the second embodiment of the present invention.

Steps 8000 to 8300 are a flow chart in which the configuration information difference generating unit 1250 adds match check data to differential data and sends the differential data added with the match check data to the configuration information difference processing unit 2250.

If the match check data is not added to the differential data, the configuration information difference processing unit 2250 does not perform Steps 8200, 8250 and 8260.

Although it is illustrated in the example of FIG. 27 that the configuration information difference processing unit 2250 updates the tables by updating the differential data sent from the configuration information difference generating unit 1250 of storage system A 1000 to the configuration information difference processing unit 2250 of storage system B 2000, the configuration information difference processing unit 2250 of storage system B 2000 may update the tables by updating the differential data regularly acquired in the configuration information difference generating unit 1250.

The configuration information difference processing unit 2250 determines whether or not a migration instruction has been received, like Step 7020 of virtual Vol migration unit II 2260 (Step 8000).

If it is determined at Step 8000 that the migration instruction has been received, the configuration information difference processing unit 2250 terminates the process.

If there remain many non-copied differential data in virtual Vol management table A 4200 and segment management table A 4300 of storage system A 1000, the configuration information difference processing unit 2250 copies the non-copied differential data to virtual Vol management table C 5700 and segment management table C 5800 and then terminates the process.

When the configuration information difference processing unit 2250 terminates the process, virtual Vol migration unit II 2260 proceeds to Step 7200.

If it is determined at Step 8000 that the migration instruction has not been received, the configuration information difference processing unit 2250 proceeds to Step 8100.

Next, the configuration information difference processing unit 2250 determines whether or not the differential data of virtual Vol management table A 4200 and segment management table A 4300 has been sent from the configuration information difference generating unit 1250 of storage system A 1000 (Step 8100).

If it is determined at Step 8100 that the differential data has not been sent, the configuration information difference processing unit 2250 returns to Step 8000.

If it is determined at Step 8100 that the differential data has been sent, the configuration information difference processing unit 2250 proceeds to Step 8200 after it receives the differential data.

Although the configuration information difference processing unit 2250 performs Step 8100 after Step 8000, it may actually monitor the migration instruction at Step 8000 and the transmission of the differential data at Step 8100 simultaneously. In this case, after the configuration information difference processing unit 2250 completes the reflection of the differential data, virtual Vol migration unit II 2260 performs steps after Step 7200.

Next, the configuration information difference processing unit 2250 creates match check data B and determines whether or not the created match check data B matches match check data A sent from the configuration information difference generating unit 1250, according to the same way as the process performed for the differential data acquired from storage system A 1000 by the configuration information difference generating unit 1250 (Step 8200).

If it is determined at Step 8200 that the match check data B matches the match check data A, the configuration information difference processing unit 2250 proceeds to Step 8300. If it is determined at Step 8200 that the match check data B does not match the match check data A, the configuration information difference processing unit 2250 proceeds to Step 8250. Match check data is a so-called Hash value and is generated by, for example, MD (Message Digest Algorithm) or the like.

If it is determined at Step 8200 that the match check data B does not match the match check data A, since the differential data received by the configuration information difference processing unit 2250 may be different from the differential data generated by the configuration information difference generating unit 1250, the configuration information difference processing unit 2250 requests the configuration information difference generating unit 1250 to again send the differential data (Step 8250).

Then, the configuration information difference processing unit 2250 waits until the configuration information difference generating unit 1250 sends the differential data again (Step 8260).

In order to implement the above-described differential data match determination process, the differential data may be given a unique identifier for identification of differential data every time it is sent. In addition, the configuration information difference processing unit 2250 may store the repetition number of Steps 8200, 8250 and 8260 for one differential data and may notify an error if the steps repeat by more than the predetermined number of times. In this case, the configuration information difference processing unit 2250 may transmit an instruction to notify an error to the management IF.

After performing Step 8250, the configuration information difference processing unit 2250 may proceed to Step 8100 without performing Step 8260.

In this case, after receiving a migration instruction at Step 8000, the configuration information difference processing unit 2250 checks whether or not there are differential data that are not updated and whether or not there are differential data that are not yet received among differential data that have been requested to be sent again. If it is checked that such differential data are present, the configuration information difference processing unit 2250 may wait transmission of such differential data, reflect such differential data and then proceed to Step 7200.

If it is determined at Step 8200 that the match check data B matches the match check data A, the configuration information difference processing unit 2250 copies the differential data to virtual Vol management table C 5700 and segment management table C 5800 of storage system A 1000, which are acquired at Step 7100 of FIG. 26 and are possessed by storage system B 2000, thereby updating these management tables (Step 8300).

Then, the configuration information difference processing unit 2250 returns to Step 8000.

Returning to FIG. 26, after completing the process of the configuration information difference processing unit 2250 shown in FIG. 27, virtual Vol migration unit II 2260 receives a migration instruction at Step 7020 and proceeds to Step 7200. The process after Step 7200 is the same as the process after Step 7200 of virtual Vol migration unit I 2210 shown in FIG. 9.

As described above, according to the second embodiment, since the configuration information of virtual Vol management table A 4200 and segment management table A 4300 of storage system A 1000 can be copied in advance as the configuration information of virtual Vol management table C 5700 and segment management table C 5800 of storage system B 2000, time taken from Pool migration instruction to migration completion can be shortened.

In addition, since storage system B 2000 has already had the virtual Vol management table and segment management table of storage system A 1000 at the point of time of migration instruction, it is possible to move volumes from storage system A 1000 to storage system B 2000 on line in association with a switching mechanism to switch volumes used in the host computer 3000 on line, as disclosed in Patent Document 1, without cutting input/output of the task program 3110 of the host computer 3000.

The present invention can be applied to various kinds of devices in addition to storage systems having dynamically-allocated storage regions and virtual volumes provided to a host computer.

What is claimed is:

1. A computer system comprising:
a first storage system including a pool, the pool including a plurality of volumes, each of which being a storage region of data provided to a host computer; and
a second storage system connected to the first storage system,
wherein the first storage system includes an interface connected to the host computer, an interface connected to the second storage system, a first processor connected to the interfaces and a first memory connected to the first processor and manages first configuration information indicating a correspondence relation between the plurality of volumes and the pool,
wherein the second storage system includes an interface connected to the host computer, an interface connected to the first storage system, a second processor connected to the interfaces and a second memory connected to the second processor, and
wherein the second processor:
acquires the first configuration information from the first storage system,
specifies a volume included in the pool of the first storage system by referring to the acquired first configuration information,
causes the specified volume to correspond to an external volume that can be handled by the second storage system, and
creates a pool having the same configuration as the pool of the first storage system in the second storage system using the corresponding external volume based on the acquired first configuration information.

2. The computer system according to claim 1,
wherein the first storage system includes a virtual volume that dynamically uses some of the storage regions of the pool,
wherein the first configuration information additionally indicates a correspondence relation between the pool and the virtual volume, and
wherein the second processor creates a virtual volume having the same configuration as the virtual volume of the first storage system in the second storage system from the created pool based on the acquired first configuration information.

3. The computer system according to claim 1,
wherein the second storage system includes a pool, the pool including a plurality of volumes, each of which being a data storage region, and manages second configuration information indicating a correspondence relation between the volumes and the pool, and
wherein, if an identifier equal to an identifier of a pool included in the acquired first configuration information is included in the second configuration information, the second processor rewrites the identifier of the pool created in the second storage system into an identifier that is not included in the second configuration information.

4. The computer system according to claim 3,
wherein the second processor notifies a correspondence relation between an identifier of a pool before the rewriting and an identifier of a pool after the rewriting.

5. The computer system according to claim 1,
wherein, if the correspondence relation between the pool included in the first configuration information and the virtual volume is changed, the first processor sends the content of change of the first configuration information to the second storage system, and
wherein the second processor updates the acquired first configuration information based on the content of change of the first configuration information acquired from the first storage system.

6. The computer system according to claim 1,
wherein the first processor creates a first error-detection code from the first configuration information, and
wherein the second processor:
acquires the first configuration information and the first error-detection code from the first storage system,
creates a second error-detection code from the acquired first configuration information,
compares the acquired first error-detection code with the created second error-detection code, and
if the first error-detection code is different from the second error-detection code, notifies the first storage system of the fact.

7. The computer system according to claim 1,
wherein, upon receiving an instruction to delete the pool indicated by the acquired first configuration information, the second processor notifies the first storage system of a change of a correspondence relation between the deleted pool included in the first configuration information and the volumes.

8. The computer system according to claim 1,
wherein, if an identifier equal to an identifier of the external volume included in the acquired first configuration information is included in the second configuration information, the second processor rewrites an identifier of the volume of second storage system, the volume corresponding to the external volume, into an identifier that is not included in the second configuration information.

9. The computer system according to claim 1,
wherein, if the computer uses the pool corresponding to the external volume, the second processor informs the computer that the volume included in the pool corresponding to the external volume can not be used.

10. The computer system according to claim 1,
wherein the second processor notifies an error if the first configuration information can not be acquired, if information of the pool created in the first storage system is not included in the acquired first configuration information, or if the volume of the first storage system can not correspond to the external volume of the second storage system.

11. A storage system comprising:
an interface connected to another storage system;
a processor connected to the interface; and
a memory connected to the processor,
wherein the another storage system includes a pool, the pool including a plurality of volumes, each of which being a storage region of data provided to a host computer and manages first configuration information indicating a correspondence relation between the plurality of volumes and the pool, and
wherein the processor:
acquires the first configuration information from the another storage system,
specifies a volume included in the pool of the another storage system by referring to the acquired first configuration information,
causes the specified volume to correspond to an external volume that can be handled by the storage system, and
creates a pool having the same configuration as the pool of the another storage system using the corresponding external volume based on the acquired first configuration information.

12. The storage system according to claim 11,
wherein the another storage system includes a virtual volume that dynamically uses some of the storage regions of the pool,
wherein the first configuration information additionally indicates a correspondence relation between the pool and the virtual volume, and
wherein the processor creates a virtual volume having the same configuration as the virtual volume of the another storage system from the created pool based on the acquired first configuration information.

13. The storage system according to claim 11,
wherein the storage system includes a pool, the pool including a plurality of volumes, each of which being a data storage region, and manages second configuration information indicating a correspondence relation between the volumes and the pool, and
wherein, if an identifier equal to an identifier of a pool included in the acquired first configuration information is included in the second configuration information, the processor rewrites the identifier of the pool created in the storage system into an identifier that is not included in the second configuration information.

14. The storage system according to claim 11,
wherein, upon receiving an instruction to delete the pool indicated by the acquired first configuration information, the processor notifies the storage system of a change of a correspondence relation between the deleted pool included in the first configuration information and the volumes.

15. A computer system comprising:
a first storage system including a pool, the pool including a plurality of volumes, each of which being a storage region of data provided to a host computer, and a virtual volume that dynamically uses some of the storage regions of the pool; and
a second storage system connected to the first storage system,
wherein the first storage system includes an interface connected to the host computer, an interface connected to the second storage system, a first processor connected to the interfaces and a first memory connected to the first processor and manages first configuration information indicating a correspondence relation between the plurality of volumes, the pool and the virtual volume,
wherein the second storage system includes an interface connected to the host computer, an interface connected to the first storage system, a second processor connected to the interfaces and a second memory connected to the second processor and manages second configuration information indicating a correspondence relation between an external volume, the pool and the virtual volume, and
wherein the second processor:
acquires the first configuration information from the first storage system,
specifies a volume included in the pool of the first storage system by referring to the acquired first configuration information,
causes the specified volume to correspond to an external volume that can be handled by the second storage system,
creates a pool having the same configuration as the pool of the first storage system in the second storage system using the corresponding external volume based on the acquired first configuration information,
creates a virtual volume having the same configuration as the virtual volume of the first storage system in the second storage system from the created pool based on the acquired first configuration information,
upon receiving an instruction to delete the pool indicated by the acquired first configuration information, notifies the second storage system of a change of a correspondence relation between the deleted pool included in the first configuration information and the volumes, and
if an identifier equal to an identifier of a volume included in the acquired first configuration information is included in the second configuration information, rewrites the identifier of the volume corresponding to the external volume of the second storage system into an identifier that is not included in the second configuration information.
